(19) United States
(12) Patent Application Publication
(10) Pub. No.: US 2002/0191956 A1
(43) Pub. Date: Dec. 19, 2002

(54) Data processing apparatus, data processing method, program-length extension and reduction apparatus, and program-length extension and reduction method

(76) Inventors: Shinichi Morishima, Kanagawa (JP); Tetsuro Suma, Kanagawa (JP)

Correspondence Address: FROMMER LAWRENCE & HAUG LLP, 745 FIFTH AVENUE, NEW YORK, NY, 10151, US

(21) Appl. No.: 10/126,366

(22) Filed: Apr. 19, 2002

(30) Foreign Application Priority Data
Apr. 20, 2001 (JP) 2001-123536

(51) Int. Cl. H04N 5/92; G11B 27/00

(52) U.S. Cl. 386/52; 386/64

(57) ABSTRACT

A program-play apparatus in a program-length adjustment system is at least provided with a data separation section for separating video data D_{PV}, a CC-data separation section for separating CC data D_{PCC}, a video memory for temporarily storing the video data D_{PV}, a CC-data memory for temporarily storing the CC data D_{PCC}, and a central processing unit (CPU) for controlling each section. The CPU reads the CC data D_{PCC} stored in the CC-data memory, inserts or deletes meaningless data into or from the CC data D_{PCC} in response to the insertion or deletion of an image constituting the video data stored in the video memory, and outputs as new CC data D_{RCC}.

### BACKGROUND OF THE INVENTION

1. Field of the Invention

The present invention relates to data processing apparatuses and data processing methods which process program-accompanying data which accompanies a program, and to program-length extension and reduction apparatuses and program-length extension and reduction methods which extend and reduce the program length of material data which constitutes a program.

2. Description of the Related Art

Recently in broadcasting stations, the time lengths of TV programs, that is, the program lengths, have been adjusted, extended or reduced, according to the lengths of commercial messages to be inserted into the TV programs. This function is called a program-play function. The program-play function is used when material data having a plurality of program lengths needs to be recorded in a video tape to handle many cases in which the time length of a commercial message is not determined until immediately before the program is broadcasted. The function is, for example, mounted on a video tape recorder (hereinafter called a VTR) or implemented by a special apparatus connected to a VTR.

Usually, VTRs record video information in units of fields into one or a plurality of recording tracks of a video tape, and reproduces the video information in units of fields from the video tape. To implement the program-play function in such VTRs, it is necessary that a reproduction head section for controlling such that a tape running speed is increased or reduced according to a program-length extension and reduction rate and for controlling the deviation of the angle of elevation of a reproduction head such that head scanning follows recording tracks be provided, and the reproduction head section perform overlap-reading or skip-reading of video information in units of frames or fields according to an increase or a reduction in a tape running speed. In other words, to implement the program-play function in VTRs, the reproduction head section scans recording tracks a plurality of times in units of frames or fields to insert video information when the program length is extended, and the reproduction head section performs skip-scanning of recording tracks in units of frames or fields to delete video information when the program length is reduced.

In this way, VTRs can adjust a program length in a range of, for example, about ±5%.

On the other hand, it has been performed in TV programs these years that various information related to the contents of programs is attached to the video information as subtitle data prepared in advance, and the subtitle data is allowed to be displayed on a screen or deleted by a user's operation. Such subtitle data is standardized in Line 21 Data Services in Electronic Industries Alliance (EIA)-608 for terrestrial analog broadcasting. What is called closed caption data has been defined, for example. Many various video output units, such as Video Home Systems (VHS, trademark), laser disk units, and digital versatile disk (DVD) units, conform to the EIA-608 standard. A similar service has been examined these days for digital broadcasting, and its standardization as EIA-708 has been started.

In Line 21 Data Services, data (hereinafter called line-21 data), such as closed caption data, is superposed on the 21st line of the vertical blanking period in video information to superpose various character information to be displayed on a screen. Character information is superposed in units of two bytes per field in Line 21 Data Services.

It is assumed here that the program-play function is applied to video information to which line-21 data has been attached. In this case, since the program-play function inserts or deletes video information in units of frames or fields, the line-21 data is destroyed and it becomes impossible to display character information appropriately.

Specifically, in Line 21 Data Services, line-21 data for displaying one character is superposed on video information only once. More specifically, in Line 21 Data Services, to display a character string “ABCDEF” in a predetermined scene of the original video information, which is to be reproduced, line-21 data for displaying “AB” is superposed on a predetermined frame, line-21 data for displaying “CD” is superposed on a different frame, and line-21 data for displaying “EF” is superposed on a yet different frame.

Therefore, in such a condition, when the program-play function inserts video information in units of frames or fields, overlap occurs on the character information to be displayed, depending on the portion where the video information is inserted. For example, when the program-play function inserts the frame on which the line-21 data for displaying “AB” has been superposed among the three frames in which the character string “ABCDEF” is displayed, a character string “ABABCDEF” is displayed. On the other hand, in such a condition, when the program-play function deletes video information in units of frames or fields, missing occurs on the character information to be displayed, depending on the portion where the video information is deleted. For example, when the program-play function deletes the frame on which the line-21 data for displaying “CD” has been superposed among the three frames in which the character string “ABCDEF” is displayed, a character string “ABEF” is displayed.

Therefore, to handle such a situation, when the program-play function is used to produce material data having a plurality of program lengths, it is conventionally necessary to record line-21 data again on the video information, increasing the load imposed on the program producer.

### SUMMARY OF THE INVENTION

The present invention has been made in consideration of the above state. It is an object of the present invention to provide a data processing apparatus, a data processing method, a program-length extension and reduction apparatus, and a program-length extension and reduction method which appropriately display character information in response to an extension or reduction of a program length.

The foregoing object is achieved in one aspect of the present invention through the provision of a data processing apparatus for processing program-accompanying data which accompanies a program, including data taking-in means for taking in the program-accompanying data superposed on video data in the original material data constituting the program, and data output means for inserting or deleting meaningless data into or from the program-accompanying data taken in by the data taking-in means, in response to the insertion or deletion of an image constituting the video data, and for outputting as new program-accompanying data.

In the data processing apparatus, the data output means inserts or deletes meaningless data into or from program-accompanying data in response to the insertion or deletion of an image constituting video data. Therefore, character information is appropriately displayed on a display screen on which the program is displayed; troublesome work for the program producer is made unnecessary to largely reduce the load imposed on the program producer; and processing is made shorter at a lower cost.

The foregoing object is achieved in another aspect of the present invention through the provision of a data processing method for processing program-accompanying data which accompanies a program, including a data taking-in step of taking in the program-accompanying data superposed on video data in the original material data constituting the program, and a data output step of inserting or deleting meaningless data into or from the program-accompanying data taken in in the data taking-in step, in response to the insertion or deletion of an image constituting the video data, and of outputting as new program-accompanying data.

In the data processing method, meaningless data is inserted or deleted into or from program-accompanying data in response to the insertion or deletion of an image constituting video data. Therefore, character information is appropriately displayed on a display screen on which the program is displayed; troublesome work for the program producer is made unnecessary to largely reduce the load imposed on the program producer; and processing is made shorter at a lower cost.

The foregoing object is achieved in still another aspect of the present invention through the provision of a program-length extension and reduction apparatus for extending and reducing the program length of the original material data constituting a program to generate processed material data, including video-data storage means for storing video data of the original material data reproduced from a predetermined recording medium and sent by a reproduction apparatus; program-length extension and reduction processing means for inserting or deleting an image constituting the video data by overlap reading or skip reading from the video-data storage means according to a program-length extension and reduction rate based on the program length of the original material data and the program length of the processed material data to extend or reduce the program length of the original material data; data taking-in means for taking in program-accompanying data which accompanies the program, superposed on the video data; and data output means for inserting or deleting meaningless data into or from the program-accompanying data taken in by the data taking-in means, in response to the insertion or deletion of an image constituting the video data, performed by the program-length extension and reduction means, and for outputting as new program-accompanying data.

In the program-length extension and reduction apparatus, the program-length extension and reduction processing means inserts or deletes an image constituting the video data by overlap reading or skip reading from the video-data storage means according to a program-length extension and reduction rate, and the data output means inserts or deletes meaningless data into or from the program-accompanying data in response to the insertion or deletion of an image constituting the video data. Therefore, even when the program length of the original material data is extended or reduced, character information is appropriately displayed on a display screen on which the program is displayed; troublesome work for the program producer is made unnecessary to largely reduce the load imposed on the program producer; and processing is made shorter at a lower cost.

The foregoing object is achieved in yet another aspect of the present invention through the provision of a program-length extension and reduction method for extending and reducing the program length of the original material data constituting a program to generate processed material data, including a video-data storage step of storing video data of the original material data reproduced from a predetermined recording medium and sent by a reproduction apparatus, into video-data storage means; a program-length extension and reduction processing step of inserting or deleting an image constituting the video data by overlap reading or skip reading from the video-data storage means according to a program-length extension and reduction rate based on the program length of the original material data and the program length of the processed material data to extend or reduce the program length of the original material data; a data taking-in step of taking in program-accompanying data which accompanies the program, superposed on the video data; and a data output step of inserting or deleting meaningless data into or from the program-accompanying data taken in in the data taking-in step, in response to the insertion or deletion of an image constituting the video data, performed in the program-length extension and reduction step, and of outputting as new program-accompanying data.

In the program-length extension and reduction method, an image constituting the video data is inserted or deleted by overlap reading or skip reading from the video-data storage means according to a program-length extension and reduction rate, and meaningless data is inserted or deleted into or from the program-accompanying data in response to the insertion or deletion of an image constituting the video data. Therefore, even when the program length of the original material data is extended or reduced, character information is appropriately displayed on a display screen on which the program is displayed; troublesome work for the program producer is made unnecessary to largely reduce the load imposed on the program producer; and processing is made shorter at a lower cost.

### BRIEF DESCRIPTION OF THE DRAWINGS

FIG. 1 is a block diagram of a program-length adjustment system according to an embodiment of the present invention.

FIG. 2 is a signal-waveform view of line-21 data.

FIG. 3 is a block diagram of a program-play apparatus of the program-length adjustment system.

FIG. 4 is a flowchart of a series of processes for calculating a program-length extension and reduction rate in the program-play apparatus.

FIG. 5 is a flowchart of setting calculation processing related to the original material data, executed in processes shown in FIG. 4.

FIG. 6 is a view showing the relationship between program-length reduction and editing blocks.

FIG. 7 is a view of program-length reduction.

FIG. 8 is a view of program-length extension.

FIG. 9A is a view showing the relationship between a reproduction reference timer and a time code in phase adjustment processing. FIG. 9B is a view showing the relationship between a recording reference timer and a time code in the phase adjustment processing.

FIG. 10 is a flowchart of a series of processes for extending and reducing a program length in the program-play apparatus.

FIG. 11 is a flowchart of phase adjustment processing performed in a reproduction VTR, executed in a process shown in FIG. 10.

FIG. 12 is a flowchart of phase adjustment processing performed in a recording VTR, executed in the process shown in FIG. 10.

FIG. 13 is a view of software modules to be executed by the CPU of the program-play apparatus when CC data is inserted or deleted.

FIG. 14A is a view showing the relationship between input video data and output video data in CC-data output processing executed by the CPU when a frame is not inserted or deleted into or from video data stored in a video memory of the program-play apparatus. FIG. 14B is a view showing the relationship between input CC data and output CC data in the CC-data output processing executed by the CPU when a frame is not inserted or deleted into or from video data stored in the video memory of the program-play apparatus.

FIG. 15A is a view showing the relationship between input video data and output video data in CC-data output processing executed by the CPU when an image is deleted in units of frames from video data stored in the video memory of the program-play apparatus. FIG. 15B is a view showing the relationship between input CC data and output CC data in the CC-data output processing executed by the CPU when an image is deleted in units of frames from video data stored in the video memory of the program-play apparatus.

FIG. 16A is a view showing the relationship between input video data and output video data in CC-data output processing executed by the CPU when an image is inserted in units of frames into video data stored in the video memory of the program-play apparatus. FIG. 16B is a view showing the relationship between input CC data and output CC data in the CC-data output processing executed by the CPU when an image is inserted in units of frames into video data stored in the video memory of the program-play apparatus.

FIG. 17A is a view showing the relationship between input video data and output video data in CC-data output processing executed by the CPU when an image is deleted in units of fields from video data stored in the video memory of the program-play apparatus. FIG. 17B is a view showing the relationship between input CC data and output CC data in the CC-data output processing executed by the CPU when an image is deleted in units of fields from video data stored in the video memory of the program-play apparatus.

FIG. 18A is a view showing the relationship between input video data and output video data in CC-data output processing executed by the CPU when an image is inserted in units of fields into video data stored in the video memory of the program-play apparatus. FIG. 18B is a view showing the relationship between input CC data and output CC data in the CC-data output processing executed by the CPU when an image is inserted in units of fields into video data stored in the video memory of the program-play apparatus.

FIG. 19 is a view showing a state in which null data is inserted in CC-data output processing executed by the CPU, so that control codes are separated.

FIG. 20 is a view showing a state in which null data is inserted in the frame immediately after a frame on which null data has been superposed in advance in the original material data, in CC-data output processing executed by the CPU.

FIG. 21 is a flowchart of a series of CC-data output processes executed by the CPU when CC data is inserted or deleted in units of frames or fields in the program-play apparatus.

FIG. 22 is a flowchart showing CC-data insertion or deletion processing executed in a process shown in FIG. 21.

### DESCRIPTION OF THE PREFERRED EMBODIMENT

An embodiment of the present invention will be described below in detail by referring to the drawings.

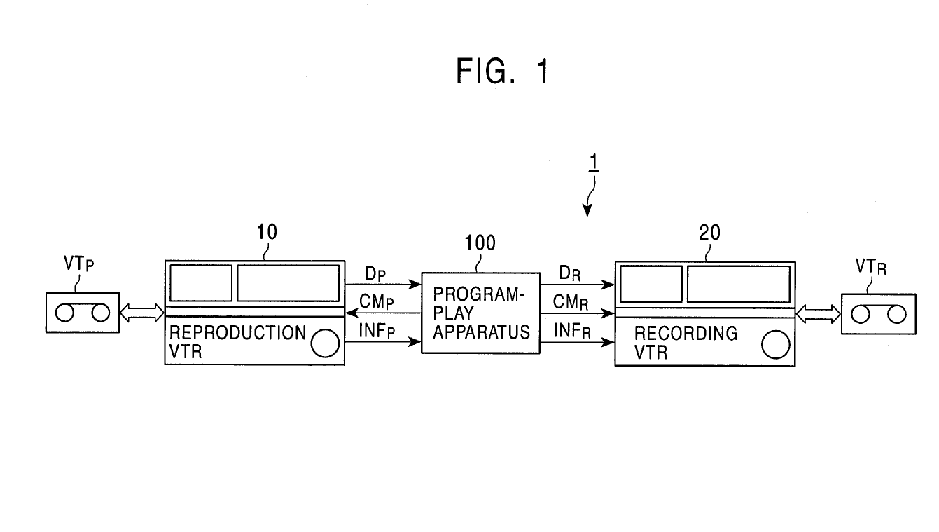

In this embodiment, a program-length adjustment system 1 provided with a program-play apparatus 100 having a program-play function, which adjusts a program length by reducing or extending it, is taken as shown in FIG. 1. In the program-length adjustment system 1, a reproduction video tape recorder (VTR) 10 reproduces at a standard reproduction speed the original material data having a usual program length, recorded in a video tape VT_{P}; the program-play apparatus 100 extends or reduces the program length of reproduced data D_{P}; a recording VTR 20 records recording data D_{R} of which the program length has been extended or reduced, into a video tape VT_{R} at a normal recording speed to generate material data having an extended or reduced program length. In other words, the program-length adjustment system 1 stores video data in a memory and performs overlap reading or skip reading of video data from the memory according to a program-length extension and reduction rate to adjust the program length in the same way as a program-length adjustment system described in Japanese Patent Application No. 2000-107067, which the present assignee has filed, unlike a case in which control is made such that a tape running speed is increased or reduced according to a program-length extension and reduction rate and the deviation of the angle of elevation of a reproduction head is controlled, so that the program length of reproduced data obtained by reproducing the original material data is adjusted.

When the original material data on which program-accompanying data which accompanies the program has been superposed is recorded in the video tape VT_{P} and the program-play apparatus 100 extends or reduces the program length of reproduced data obtained by reproducing the original material data, the program-length adjustment system 1 allows the program-accompanying data to be appropriately displayed on a display screen on which the program is displayed.

Before the program-length adjustment system 1 is described, closed caption data (hereinafter called CC data) serving as program-accompanying data will be described briefly.

CC data is subtitle data created in advance based on the contents of the program, and is standardized in Line 21 Data Services in Electronic Industries Alliance (EIA)-608 for terrestrial analog broadcasting. In Line 21 Data Services, in addition to a service for attaching CC data to video information, a service for attaching text data generated in advance as information indirectly related to the contents of the program to video information, and an extended data service (hereinafter called XDS) for attaching the contents of the program and other types of information to video information are provided. In Line 21 Data Services, these pieces of data (hereinafter called line-21 data), including CC data, are superposed on the 21st line in the vertical blanking period in video information. Specifically, Line 21 Data Services are provided with the following data channels shown in Table 1, and independent pieces of data are used for each of the first field and the second field.

TABLE 1

| First-Field Packets (Field-1 | Second-Field Packets (Field-2 |
|---|---|
| Packets) | Packets) |
| CC1 (Primary synchronous | CC3 (Secondary Synchronous |
| Caption Service) | Caption Service) |
| CC2 (Special Non-Synchronous | CC4 (Special Non-Synchronous |
| Use Captions) | Use Captions) |
| T1 (First Text Service) | T3 (Third Text Service) |
| T2 (Second Text Service) | T4 (Fourth Text Service) |
| | XDS (Extended Data Service) |

In Line 21 Data Service, CC data is superposed on each field as the primary synchronous caption service (CC1), the secondary synchronous caption service (CC3), and the special non-synchronous use captions (CC2 and CC4) shown in Table 1. CC1 is caption data literally or almost literally expressed in a first language, that is, in the same language as that used in the program, and is superposed on the first field. CC3 is selective caption data usually expressed in a second language, that is, in a language different from that used in the program, or expressed in a easier-to-read manner than in CC1, and is superposed on the second field. CC2 and CC4 are predetermined data to be transmitted to increase program information. CC2 is superposed on the first field, and CC4 is superposed on the second field.

In Line 21 Data Services, text data is superposed on each field as the first text service (T1), the second text service (T2), the third text service (T3), and the fourth text service (T4) shown in Table 1. XDS is superposed on the second field in Line 21 Data Services. Since XDS is superposed on the second field in Line 21 Data Services, text data is usually superposed on the first field as T1 and/or T2, and T3 and T4 are used only when more text data needs to be transmitted in addition to T1 and T2.

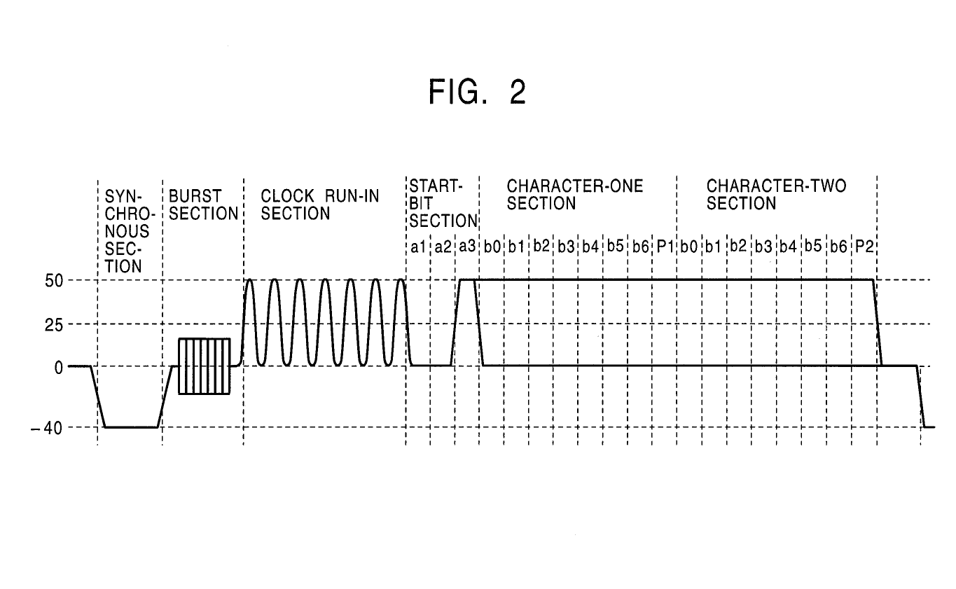

FIG. 2 shows a signal waveform of line-21 data. The line-21 data is formed of a synchronous section where a synchronizing signal (H Sync) is recorded; a burst section where a burst signal (color burst) is recorded; a clock run-in section where a clock run-in is recorded; a start-bit section where start bits are recorded; a character-one section where character one is recorded; and a character-two section where character two is recorded. In a usual video signal, data is recorded after the synchronizing signal and the burst signal. In contrast, in line-21 data, the clock run-in, start bits, character one, and character two are recorded after the synchronizing signal and the burst signal. The clock run-in is a symmetrical sine wave in which a logical level “1” indicates the maximum amplitude and a logical level “0” indicates the minimum amplitude. In line-21 data, three start bits “s1,” “s2,” and “s3” are recorded after the clock run-in. The start bits “s1,” “s2,” and “s3” are defined as “0,” “0,” and “1.” Following the start bits in line-21 data, character one having a length of one byte is recorded. Character one is formed of seven data bits “b0,” “b1,” “b2,” “b3,” “b4,” “b5,” and “b6,” and one parity bit “P1.” Following character one in line-21 data, character two having a length of one byte is recorded. In the same way as in character one, character two is formed of seven data bits “b0,” “b1,” “b2,” “b3,” “b4,” “b5,” and “b6,” and one parity bit “P2.”

With the use of line-21 data having such a signal waveform, character information can be superposed in units of two bytes per field as indicated by character one and character two. Character information is transmitted in units of two bytes in Line 21 Data Services.

Line-21 data indicates character-information data or a control code. A control code is superposed on video information to instruct the display form of character information, and includes, for example, an instruction for a line where character information is displayed, an instruction for actually displaying transmitted character information on a display screen, and an instruction for scrolling up displayed character information. When line-21 data indicates a control code, seven data bits of “0x01” to “0x1f” are stored in character one based on contents, and character two having a predetermined value is attached to character one. On the other hand, when line-21 data indicates character-information data, seven data bits of “0x20” to “0x7f” are stored in character one and character two. When line-21 data is XDS, a check sum is added. The check sum ranges from “0x00” to “0x7f.” The value of the check sum is stored in the seven data bits of character two, and character one has a value of “0x0f.” In line-21 data, when the seven data bits of character one and character two have “0x00,” they do not indicate any specific meaningful information, such as character information or a control code, but are meaningless data. This meaningless data is hereinafter called null data.

The standardization of the same kind of services for digital TVs has been started as EIA-708. EIA-708 has the same data structures as EIA-608 in many cases.

The program-length adjustment system 1 shown in FIG. 1 adjusts the program length of reproduced data D_{P} obtained by reproducing the original material data on which such line-21 data used in Line 21 Data Services has been superposed. For convenience of description, CC data will be taken below as a representative of line-21 data and it is assumed that the program-length adjustment system 1 reproduces the original material data on which CC data has been superposed.

As shown in FIG. 1, the program-length adjustment system 1 is provided with the reproduction VTR 10 from which the video tape VT_{P} in which the original material data having a usual program length has been recorded is detachable; the program-play apparatus 100 which extends or reduces the program length of reproduced data D_{P} output from the reproduction VTR 10; and the recording VTR 20 from which the video tape VT_{R} for recording recording data D_{R} output from the program-play apparatus 100 is detachable.

The reproduction VTR 10 is a digital VTR for reproducing data compressed in units of frames. The reproduction VTR 10 reproduces at a standard reproduction speed the original material data recorded in the video tape VT_{P} according to a control command CM_{P} output from the program-play apparatus 100. The reproduction VTR 10 converts reproduced video data, audio data, reference data, and CC data to have, for example, the serial digital interface (SDI) format standardized in Society of Motion Picture and Television Engineers (SMPTE)-259M, and outputs the reproduced data D_{P} formed of serial data in which these various pieces of data have been multiplexed, to the program-play apparatus 100. The reproduction VTR 100 also outputs operation-state information INF_{P} indicating an operation state to the program-play apparatus 100.

As details will be described later, the program-play apparatus 100 extends or reduces an image constituting video data in the reproduced data D_{P} in units of frames or fields according to a program-length extension and reduction rate specified in advance by the user, such as a program producer, to extend or reduce the program length of the original material data. The program-play apparatus 100 converts video data, audio data, reference data, and CC data for which the program length has been extended or reduced, to have the SDI format, and outputs the recording data D_{R} formed of serial data in which these pieces of data have been multiplexed, to the recording VTR 20.

The recording VTR 20 is a digital VTR for compressing and recording data in units of frames. The VTR 20 receives from the program-play apparatus 100 the recording data D_{R} formed of serial data in which various pieces of data have been multiplexed according to the SDI format, in response to a control command CM_{R} output from the program-play apparatus 100, and records the recording data into the video tape VT_{R} at a normal recording speed. The recording VTR 20 also outputs operation-state information INF_{R} indicating an operation state to the program-play apparatus 100.

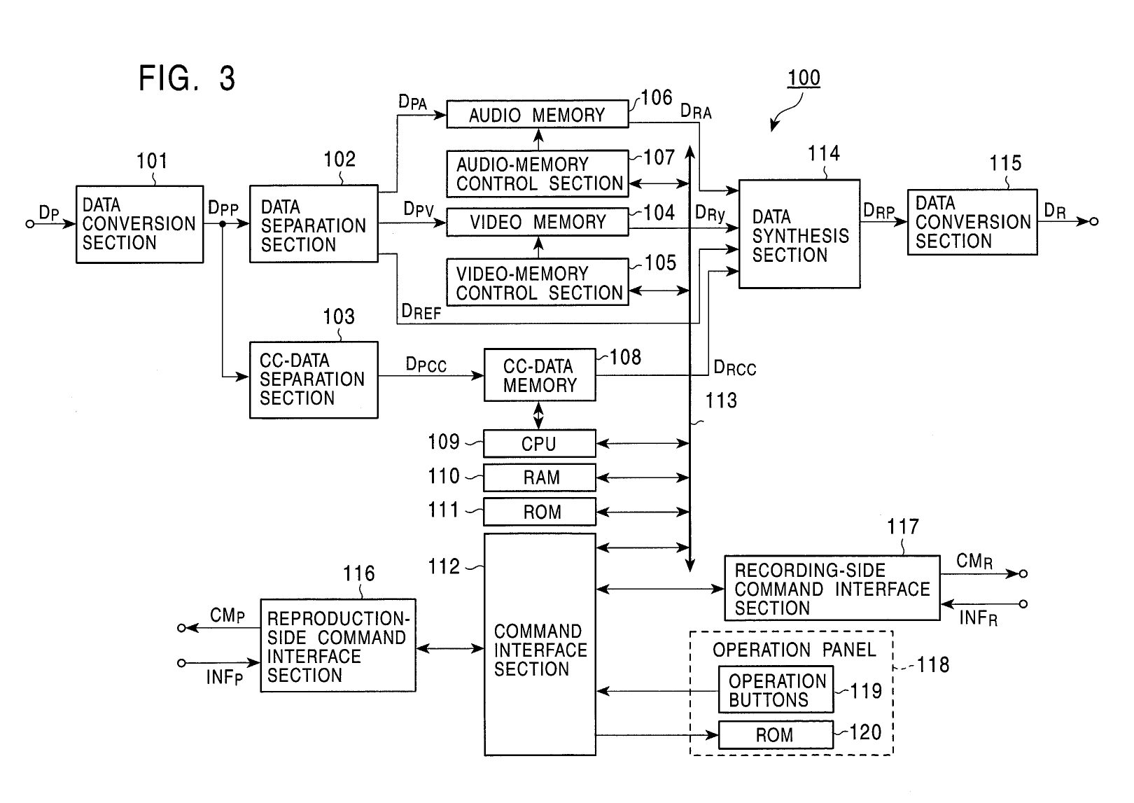

The program-play apparatus 100 in the program-length adjustment system 1 is formed, as shown in FIG. 3, of a data conversion section 101 for converting the reproduced data D_{P} formed of serial data to parallel data; a data separation section 102 serving as data separation means for separating video data D_{PV}, audio data D_{PA}, and reference data D_{REF} from parallel data D_{PP} sent from the data conversion section 101; a CC-data separation section 103 serving as program-accompanying data separation means for separating CC data D_{PCC} from the parallel data D_{PP} sent from the data conversion section 101; a video memory 104 serving as video-data storage means for temporarily storing the video data D_{PV} separated by the data separation section 102; a video-memory control section 105 for controlling writing and reading of video data into and from the video memory 104; an audio memory 106 for temporarily storing the audio data D_{PA} separated by the data separation section 102; an audio-memory control section 107 for controlling writing and reading of audio data into and from the audio memory 106; a CC-data memory 108 for temporarily storing the CC data D_{PCC} separated by the CC-data separation section 103; a central processing unit (CPU) 109 for controlling each section; a random access memory (RAM) 110 serving as storage means which functions as a working area for temporarily storing various types of data; a read only memory (ROM) 111 for storing various programs; a command interface section 112 for transmitting and receiving control signals, such as various commands; a bus 113 for connecting the video-memory control section 105, the audio-memory control section 107, the CPU 109, the RAM 110, the ROM 111, and the command interface section 112; a data synthesis section 114 serving as data synthesis means for synthesizing video data D_{RV}, audio data D_{RA}, reference data D_{REF}, and CC-data D_{RCC}; a data conversion section 115 for converting parallel data D_{RP} sent from the data synthesis section 114 to serial data; a reproduction-side command interface section 116 for transmitting and receiving a control command CM_{P} and operation-state information INF_{P} to and from the reproduction VTR 10; a recording-side command interface 117 for transmitting and receiving a control command CM_{R} and operation-state information INF_{R} to and from the recording VTR 20; and an operation panel 118 serving as a user interface.

The data conversion section 101 receives the reproduced data D_{PV}, output from the reproduction VTR 10 and converts it to parallel data. The data conversion section 101 also converts the obtained parallel data to National Television System Committee (NTSC) data or others as necessary. The data conversion section 101 sends the obtained parallel data D_{PP} to the data separation section 102 and to the CC-data separation section 103.

The data separation section 102 separates the video data D_{PV}, the audio data D_{PA}, and the reference data D_{REF} from the parallel data D_{PP}. The data separation section 102 sends the obtained video data D_{PV} to the video memory 104 and makes it temporarily store the data; sends the obtained audio data D_{PA} to the audio memory 106 and makes it temporarily store the data; and sends the obtained reference data D_{REF} to the data synthesis section 114.

The CC-data separation section 103 separates the CC data D_{PC} from the parallel data D_{PP}. The CC-data separation section 103 sends the obtained CC data D_{PCC} to the CC-data memory 108 and makes it temporarily store the data. The program-play apparatus 100 has the CC-data separation section 103 as an independent block different from the data conversion section 101 and the data separation section 102. This is because the CC-data separation section 103 can be formed of a commercial integrated circuit at a low cost. The program-play apparatus 100 may have one block which includes the data conversion section 101, the data separation section 102, and the CC-data separation section 103.

The video memory 104 receives the video data D_{PV} separated by the data separation section 102. The video memory 104 temporarily stores the received video data D_{PV} under the control of the video-memory control section 105. Video data stored in the video memory 104 is read therefrom under the control of the video-memory control section 105, and is sent to the data synthesis section 114 as the video data D_{RV}.

The video-memory control section 105 controls writing and reading of video data into and from the video memory 104 according to an instruction sent from the CPU 109 through the bus 113.

The audio memory 106 receives the audio data D_{PA} separated by the data separation section 102. The audio memory 106 temporarily stores the received audio data D_{PA} under the control of the audio-memory control section 107. Audio data stored in the audio memory 106 is read therefrom under the control of the audio-memory control section 107, and is sent to the data synthesis section 114 as the audio data D_{RA}.

The audio-memory control section 107 controls writing and reading of audio data into and from the audio memory 106 according to an instruction sent from the CPU 109 through the bus 113.

The CC-data memory 108 receives the CC data D_{PCC} separated by the CC-data separation section 103. The CC-data memory 108 temporarily stores the received CC data D_{PCC} under the control of the CPU 109. The CC data D_{RCC} to which processing has been applied by the CPU 109 is read from the CC-data memory 108, and is sent to the data synthesis section 114.

The CPU 109 reads a program for implementing the program-play function, stored in the ROM 111, and executes the program. The CPU 109 generates a control command CM_{P} for controlling the reproduction VTR 10, and sends the control command CM_{P} to the reproduction-side command interface section 116 through the bus 113. The CPU 109 also receives the operation-state information INF_{P} indicating the operation state of the reproduction VTR 10 through the bus 113 from the reproduction-side command interface section 116, and understands the operation state of the reproduction VTR 10 according to the operation-state information INF_{P}. In the same way, the CPU 109 generates a control command CM_{R} for controlling the recording VTR 20, and sends the control command CM_{R} to the recording-side command interface section 117 through the bus 113. The CPU 109 also receives the operation-state information INF_{R} indicating the operation state of the recording VTR 20 through the bus 113 from the recording-side command interface section 117, and understands the operation state of the recording VTR 20 according to the operation-state information INF_{R}.

Further, the CPU 109 sends instructions to the video-memory control section 105 and to the audio-memory control section 107 through the bus 113 in response to a frame pulse or a field pulse, and controls writing and reading of video data and audio data into and from the video memory 104 and the audio memory 106 according to a program-length extension and reduction rate specified in advance. More specifically, the CPU 109 reads an image constituting video data stored in the video memory 104, in synchronization with a predetermined field frequency in units of frames or fields, and sends it to the data synthesis section 114 as the video data D_{RV}. In this case, the CPU 109 inserts or deletes an image in units of frames or fields according to the program-length extension and reduction rate specified in advance to increase or reduce the number of frames or fields in the video data D_{RV} to determine the program length of the video data D_{RV}. At the same time, the CPU 109 reads audio data stored in the audio memory 106, in synchronization with the video data D_{RV}, and sends the audio data to the data synthesis section 114 as the audio data D_{RA}.

Furthermore, as details will be described later, the CPU 109 controls writing and reading of CC data into and from the CC-data memory 108. The CPU 109 reads the CC data D_{PCC} sent from the CC-data separation section 103 to the CC-data memory 108 and stored therein; inserts or deletes the null data described above, according to the program-length extension and reduction rate specified in advance to generate new CC data D_{RCC} corresponding to the video data D_{RV} and the audio data D_{RA}; and writes the CC data D_{RCC} into the CC-data memory 108. The CPU 109 reads the new CC data D_{RCC} written into the CC-data memory 108 and sends it to the data synthesis section 114.

The RAM 110 is used as a working area for extending or reducing the program length, under the control of the CPU 109 through the bus 113, and temporarily stores various types of data.

The ROM 111 stores the program for implementing the program-play function. As described above, the program is developed into the RAM 110 under the control of the CPU 109 through the bus 113.

The command interface section 112 receives a control command CM_{P} generated by the CPU 109, through the bus 113 and sends it to the reproduction-side command interface section 116, and sends the operation-state information INF_{P} received from the reproduction-side command interface 116, to the CPU 109 through the bus 113. In the same way, the command interface section 112 receives a control command CM_{R} generated by the CPU 109, through the bus 113 and sends it to the recording-side command interface section 117, and sends the operation-state information INF_{R} received from the recording-side command interface 117, to the CPU 109 through the bus 113. Further, the command interface section 112 receives various control signals generated when the user performs operations through the operation panel 118 and sends the control signals to the CPU 109 through the bus 113, and receives various types of information generated by the CPU 109 to be displayed to the user and sends the information to the operation panel 118.

The data synthesis section 114 superposes the CC data D_{RCC} read from the CC-data memory 108 in a vertical blanking period of the video data D_{RV} read from the video memory 104, and synthesizes the audio data D_{RA} read from the audio memory 106 and the reference data D_{REF} sent from the data separation section 102 to generate the parallel data D_{RP}. The data synthesis section 114 sends the generated parallel data D_{RP} to the data conversion section 115.

The data conversion section 115 converts the parallel data D_{RP} sent from the data synthesis section 114 to serial data having the SDI format. The data conversion section 115 outputs the recording data D_{R} obtained by the conversion to the recording VTR 20.

The reproduction-side command interface section 116 outputs the control command CM_{P} sent from the command interface section 112, to the reproduction VTR 10, and sends the operation-state information INF_{P} output from the reproduction VTR 10, to the command interface section 112.

The recording-side command interface section 117 outputs the control command CM_{R} sent from the command interface section 112, to the recording VTR 20, and sends the operation-state information INF_{R} output from the recording VTR 20, to the command interface section 112.

The operation panel 118 is provided with operation buttons 119 used by the user for various setting inputs, and a display section 120 for displaying various types of setting information. The operation panel 118 has, as the operation buttons 119, a setting button for starting setting a start time, an end time, and a program length for the original material data recorded in the video tape VT_{P} loaded into the reproduction VTR 10, and for starting setting a start time, an end time, and a program length for the processed material data recorded in the video tape VT_{R} loaded into the recording VTR 20; input buttons for inputting various settings; a clear button for clearing various settings; a settle button for settling input various settings and for storing them in the RAM 110; a start button for executing the program for implementing the program-play function, stored in the ROM 111 to start program-length extension and reduction processing; an end button for interrupting the program-length extension and reduction processing to forcedly finish it; and others (none of the buttons are shown in the figure). The operation panel 118 has a setting display area (not shown) for displaying various settings and others (not shown) as the display section 120.

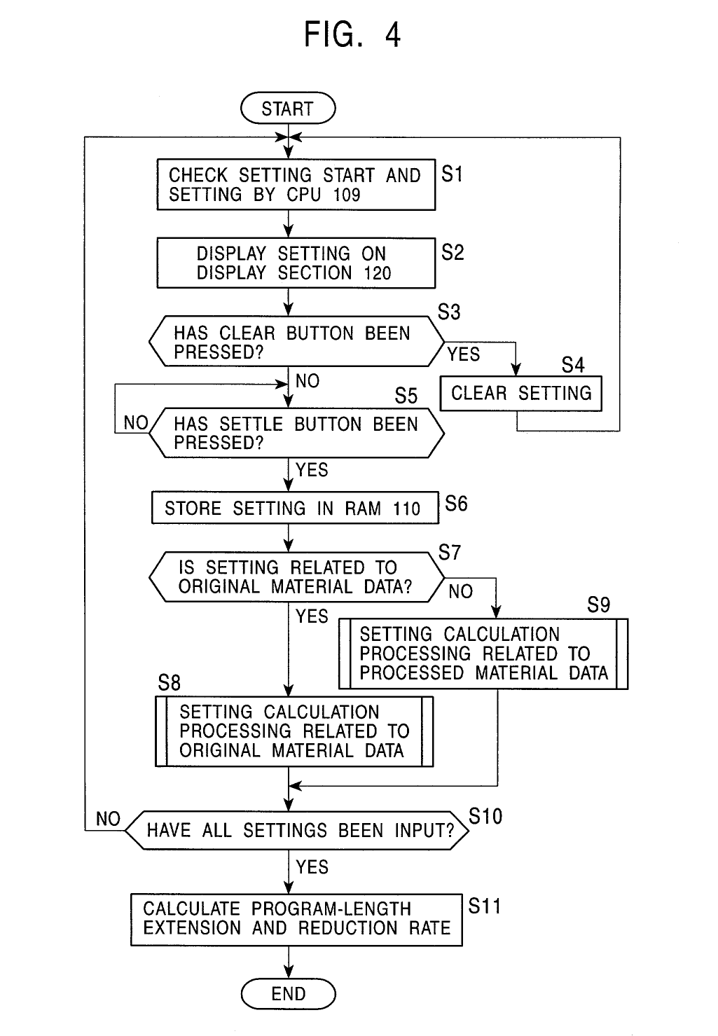

The program-play apparatus 100 calculates, through a series of processes shown in FIG. 4, a program-length extension and reduction rate (rate calculation processing) according to the program length of the original material data to be reproduced and the program length of the processed material data to be recorded, the lengths being obtained by various settings specified by the user with the use of the operation panel 118.

In other words, in the program-play apparatus 100, when the user presses the setting button among the operation buttons 119 on the operation panel 118 to start various settings, and then presses input buttons to input a setting, a control signal indicating the user's operation is sent to the CPU 109 through the command interface section 112 and the bus 113. The CPU 109 checks that various types of setting have been started and also checks the input setting in step S1 as shown in FIG. 4.

Then, in step S2, the setting is displayed at the setting display area on the display section 120 of the operation panel 118 under the control of the CPU 109 in the program-play apparatus 100.

Then, in step S3, the CPU 109 determines whether the user has pressed the clear button among the operation buttons 119 on the operation panel 118 in the program-play apparatus 100.

When the clear button has been pressed, the program-play apparatus 100 clears the setting displayed at the setting display area under the control of the CPU 109 in step S4, and the processing proceeds to step S1.

When the clear button has not been pressed, the CPU 109 determines in step S5 whether the user has pressed the settle button among the operation buttons 119 on the operation panel 118 in the program-play apparatus 100.

When the settle button has not been pressed, the program-play apparatus 100 waits for the settle button to be pressed, under the control of the CPU 109.

When the settle button has been pressed, the program-play apparatus 100 stores the setting in the RAM 110 in step S6 under the control of the CPU 109, and the processing proceeds to step S7.

Then, in step S7, the CPU 109 determines whether the input setting is related to the original material data to be reproduced, in other words, whether the input setting indicates the start time, the end time, or the program length of the original material data recorded in the video tape VT_{P} loaded into the reproduction VTR 10, in the program-play apparatus 100.

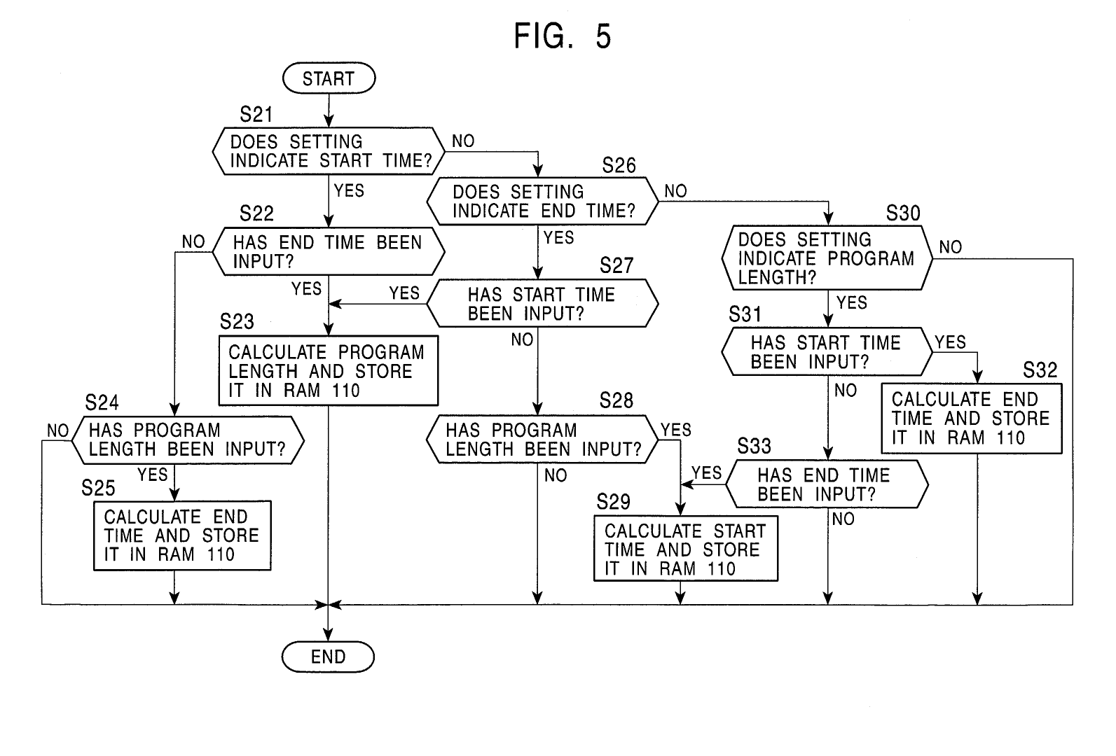

When the input setting is related to the original material data to be reproduced, the program-play apparatus 100 performs setting calculation processing for the original material data in step S8 under the control of the CPU 109. This setting calculation processing has a series of processes shown in FIG. 5.

As shown in FIG. 5, the CPU 109 determines in step S21 whether the input setting indicates the start time, in the program-play apparatus 100.

When it is determined that the input setting indicates the start time, the CPU 109 determines in step S22 whether the end time has been input and stored in the RAM 110, in the program-play apparatus 100.

When it is determined that the end time has been input, the CPU 109 calculates the program length according to the start time and the end time and stores it in the RAM 110 in step S23 in the program-play apparatus 100, the series of setting calculation processing is finished, and the rate calculation processing proceeds to step S10 shown in FIG. 4.

When it is determined that the end time has not yet been input, the CPU 109 determines in step S24 whether the program length has been input and stored in the RAM 110, in the program-play apparatus 100.

When it is determined that the program length has not yet been input, the program-play apparatus 100 finishes the series of setting calculation processing, and the rate calculation processing proceeds to step S10 shown in FIG. 4. When it is determined that the program length has been input, the CPU 109 calculates in step S25 the end time according to the start time and the program length and stores it in the RAM 110, the series of setting calculation processing is finished, and the rate calculation processing proceeds to step S10 shown in FIG. 4.

When it is determined in step S21 that the input setting does not indicate the start time, the CPU 109 determines in step S26 whether the input setting indicates the end time, in the program-play apparatus 100.

When it is determined that the input setting indicates the end time, the CPU determines in step S27 whether the start time has been input and stored in the RAM 110, in the program-play apparatus 100.

When it is determined that the start time has been input, the processing proceeds to step S23, and the CPU 109 calculates the program length according to the start time and the end time and stores it in the RAM 110 in the program-play apparatus 100, the series of setting calculation processing is finished, and the rate calculation processing proceeds to step S10 shown in FIG. 4, as described above.

When it is determined that the start time has not yet been input, the CPU 109 determines in step S28 whether the program length has been input and stored in the RAM 110, in the program-play apparatus 100.

When it is determined that the program length has not yet been input, the program-play apparatus 100 finishes the series of setting calculation processing, and the rate calculation processing proceeds to step S10 shown in FIG. 4. When it is determined that the program length has been input, the CPU 109 calculates in step S29 the start time according to the end time and the program length and stores it in the RAM 110, the series of setting calculation processing is finished, and the rate calculation processing proceeds to step S10 shown in FIG. 4.

When it is determined in step S26 that the input setting does not indicate the end time, the CPU 109 determines in step S30 whether the input setting indicates the program length, in the program-play apparatus 100.

When it is determined that the input setting does not indicate the program length, the program-play apparatus 100 finishes the series of setting calculation processing, and the rate calculation processing proceeds to step S10 shown in FIG. 4. When it is determined that the input setting indicates the program length, the CPU 109 determines in step S31 whether the start time has been input and stored in the RAM 110.

When it is determined that the start time has been input, the CPU 109 calculates the end time according to the start time and the program length and stores it in the RAM 110 in the program-play apparatus 100, the series of setting calculation processing is finished, and the rate calculation processing proceeds to step S10 shown in FIG. 4.

When it is determined that the start time has not yet been input, the CPU 109 determines in step S33 whether the end time has been input and stored in the RAM 110, in the program-play apparatus 100.

When it is determined that the end time has not yet been input, the program-play apparatus 100 finishes the series of setting calculation processing, and the rate calculation processing proceeds to step S10 shown in FIG. 4. When it is determined that the end time has been input, the processing proceeds to step S29 and, as described above, the CPU 109 calculates the start time according to the end time and the program length and stores it in the RAM 110, the series of setting calculation processing is finished, and the rate calculation processing proceeds to step S10 shown in FIG. 4.

The program-play apparatus 100 performs the above setting calculation processing in step S8 when it is determined in step S7 shown in FIG. 4 that the input setting is related to the original material data to be reproduced.

When it is determined in step S7 that the input setting is not related to the original material data to be reproduced, in other words, that the input setting indicates the start time, the end time, or the program length of the processed material data to be recorded in the video tape VT_{R} loaded into the recording VTR 20, the program-play apparatus 100 performs setting calculation processing related to the processed material data to be recorded, in step S9 under the control of the CPU 109. This setting calculation processing uses two setting items among the start time, the end time, and the program length to calculate the remaining one setting item, in the same way as in the series of processes shown in FIG. 5.

When the setting calculation processing is finished in step S8 or S9 in this way, the CPU 109 determines in step S10 whether all settings have been input and stored in the RAM 110, in the program-play apparatus 100.

When it is determined that all settings have not yet been input, the rate calculation processing proceeds to step S1. When it is determined that all settings have been input, the CPU 109 calculates the program-length extension and reduction rate according to the program length of the original material data to be reproduced and the program length of the processed material data to be recorded, in step S11, and the series of process is finished. The program-length extension and reduction rate is indicated by the following expression (1), where N indicates the program-length extension and reduction rate, TL_{P} indicates the program length of the original material data to be reproduced, and TL_{R} indicates the program length of the processed material data to be recorded.

N=(TL_{R}−TL_{P})/TL_{P} (1)

The program-play apparatus 100 can calculate the program-length extension and reduction rate in this way. When the user presses the start button among the operation buttons 119 on the operation panel 118, the program-play apparatus 100 extends or reduces the program length by performing overlap reading or skip reading of the reproduction data D_{P}, at the calculated program-length extension and reduction rate under the control of the CPU 109 functioning as program-length extension and reduction processing means. More specifically, as described above, the program-play apparatus 100 temporarily stores the video data D_{PV} in the video memory 104, inserts or deletes an image in units of frames or fields at the program-length extension and reduction rate from the video memory 104 to increase or reduce the number of frames or fields in the video data D_{RV} to determine the program length of the video data D_{RV}.

Generally, to extend or reduce the program length in this way, it can be considered that all of the video data D_{PV} is temporarily stored in the video memory 104 and read. In this case, the required storage capacity of the video memory 104 may be increased according to the program length.

In the program-play apparatus 100, the video memory 104 has a storage capacity smaller than that required for the program length, the capacity being, for example, for 10 seconds (for 300 frames), and the program length is extended or reduced in units of editing blocks determined according to the storage capacity of the video memory 104 and the program-length extension and reduction rate. The program-play apparatus 100 selects the length of the editing block such that the amount of extension or reduction per editing block, that is, the number of frames or fields to be increased or reduced, is equal to or smaller than the storage capacity (the number of storable frames) of the video memory 104.

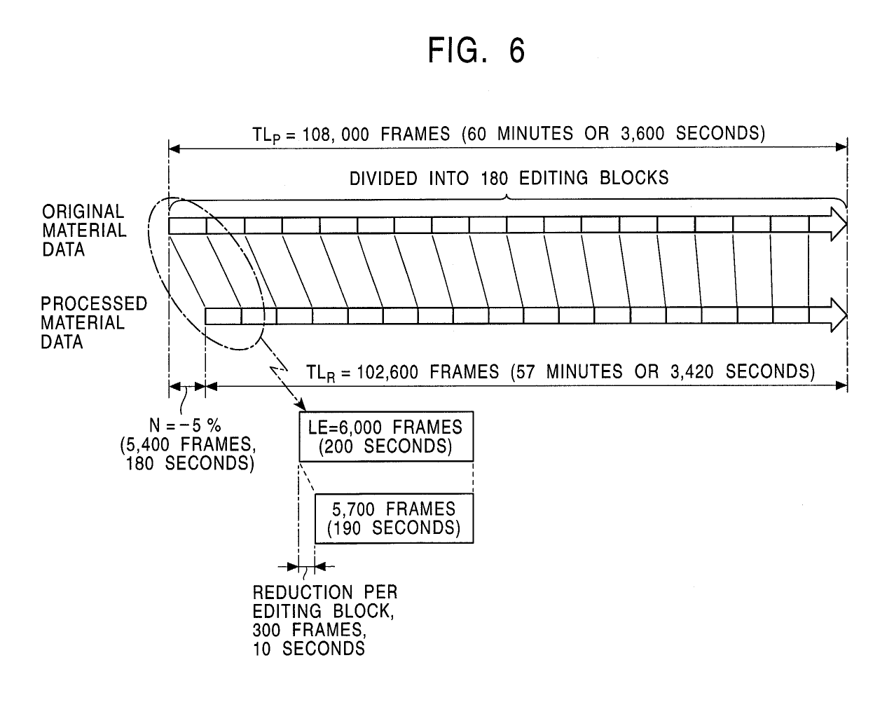

As shown in FIG. 6, for example, when the program length TL_{P} of the original material data is set to 108,000 frames (60 minutes, or 3,600 seconds), the program-length extension and reduction rate N is set to −5% (5,400-frame or 180-second reduction), and the storage capacity of the video memory 104 is set to 300 frames (10 seconds), the length LE of the editing block is set to 6,000 frames at the maximum.

In the program-play apparatus 100, the CPU 109 controls the reproduction VTR 10 to reproduce one editing block of the original material data and sequentially stores the video data D_{PV} in the video memory 104; and sequentially read video data stored in the video memory 104 by overlap reading or skip reading at the rate corresponding to the program-length extension and reduction rate N and sends it to the data synthesis section 114 as the video data D_{RV}.

When the program-play apparatus 100 reduces the program length at a program-length extension and reduction rate of −5%, for example, the CPU 109 performs skip reading of one frame in 20 frames to reduce one editing block (6,000 frames) by 300 frames.

When the program-play apparatus 100 extends the program length at a program-length extension and reduction rate of +5%, for example, the CPU 109 performs overlap reading of one frame in 20 frames to extend one editing block (6,000 frames) by 300 frames.

Then, the CPU 109 controls the recording VTR 20 to store the recording data D_{R} in the video tape VT_{R} in units of editing blocks.

To extend and reduce the program length in units of editing blocks in this way, it is necessary to synchronize the reproduction of an editing block in the reproduction VTR 10 with the recording of an editing block in the recording VTR 20.

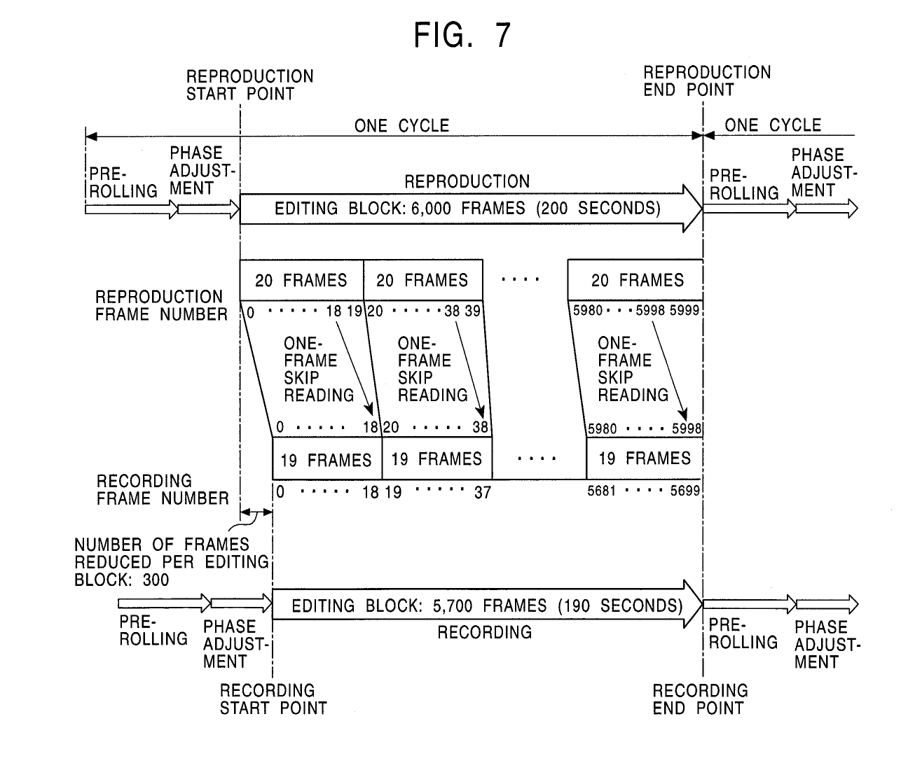

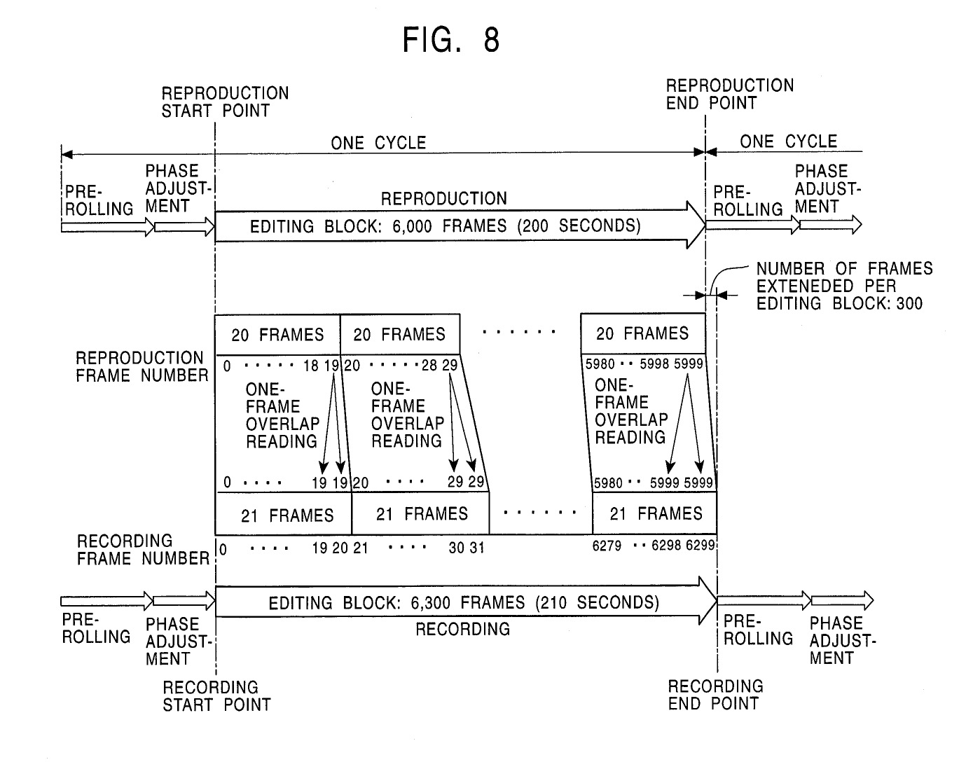

In other words, in program-length reduction processing, the program-play apparatus 100 needs to control the reproduction VTR 10 and the recording VTR 20 such that the reproduction end point of an editing block in the reproduction VTR 10 is identical with the recording end point of the editing block in the recording VTR 20, as shown in FIG. 7. In program-length extension processing, the program-play apparatus 100 needs to control the reproduction VTR 10 and the recording VTR 20 such that the reproduction start point of an editing block in the reproduction VTR 10 is identical with the recording start point of the editing block in the recording VTR 20, as shown in FIG. 8. Such synchronous control for the reproduction VTR 10 and the recording VTR 20 is called phase adjustment.

Prior to the phase adjustment, the program-play apparatus 100 applies pre-rolling for rewinding the video tapes VT_{P} and VT_{R} to the reproduction VTR 10 and to the recording VTR 20 until a predetermined time, for example, five minutes (150 frames) before the reproduction start point and the recording start point, under the control of the CPU 109.

After pre-rolling is completed, the CPU 109 executes phase adjustment, starts counting at a reproduction reference timer (not shown) and at a recording reference timer (not shown), and starts running the video tapes VT_{P} and VT_{R} in the reproduction VTR 10 and the recording VTR 20, in the program-play apparatus 100.

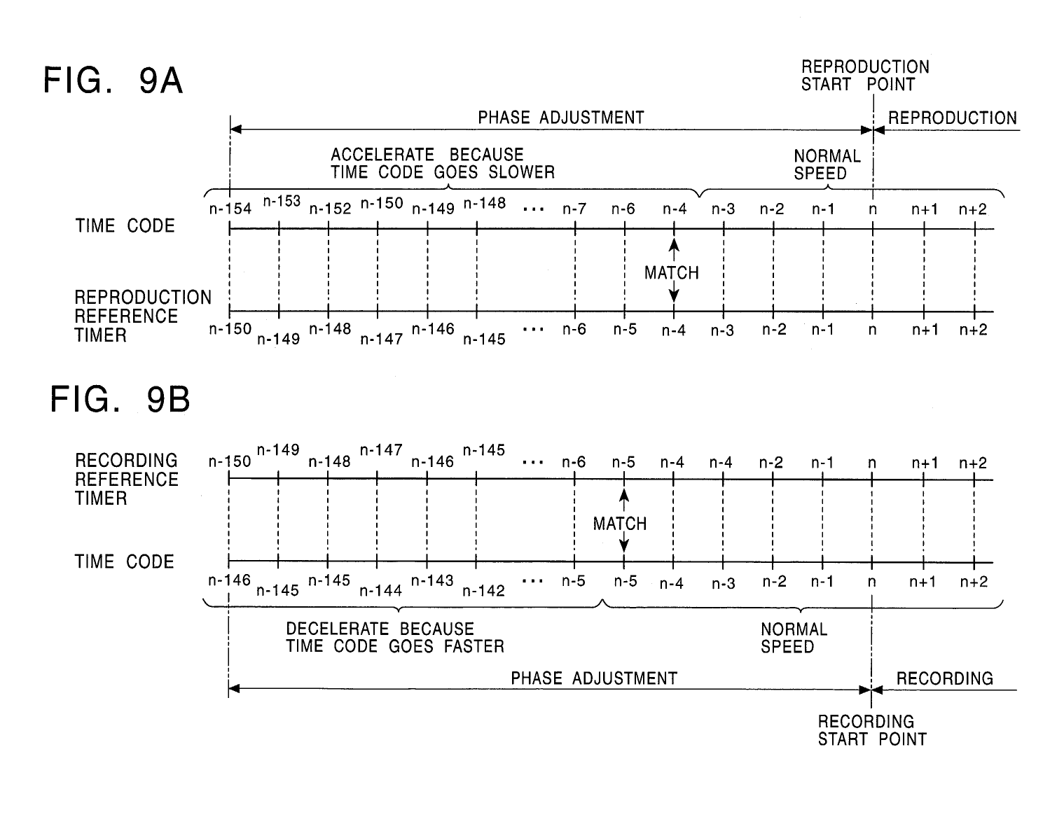

The program-play apparatus 100 performs phase adjustment processing such that the reproduction start point and the recording start point occur at the same timing, as shown in FIG. 9, when the program length is extended. The program-play apparatus 100 performs phase adjustment processing such that the reproduction start point precedes the recording start point by the length reduced in the program length, as shown in FIG. 7, when the program length is reduced.

In FIG. 9, when the time code of the reproduction start point is set to “n” and the amount of pre-rolling is set to 150 frames (five seconds), the program-play apparatus 100 starts counting at the reproduction reference timer at “n−150” by the CPU 109 as shown in FIG. 9A. In the program-play apparatus 100, the CPU 109 adjusts, increases or reduces, the tape running speed of the video tape VT_{P} in the reproduction VTR 10 such that the time code of the reproduction VTR 10 matches the count of the reproduction reference timer at timing before the reproduction start point.

When the time code of the reproduction VTR 10 matches the count of the reproduction reference counter, as shown at a timing of “n−4” of the reproduction reference timer, the CPU 109 returns the tape running speed of the video tape VT_{P} to the normal speed in the reproduction VTR 10, makes the reproduction VTR 10 start reproducing the original material data at a timing of “n” of the time code of the reproduction VTR 10, and starts storing the video data D_{PV} in the video memory 104, in the program-play apparatus 100.

On the other hand, the program-play apparatus 100 starts counting at the recording reference timer at “n−150” by the CPU 109 as shown in FIG. 9B. In the program-play apparatus 100, the CPU 109 adjusts, increases or reduces, the tape running speed of the video tape VT_{R} in the recording VTR 20 such that the time code of the recording VTR 20 matches the count of the recording reference timer at timing before the recording start point.

When the time code of the recording VTR 20 matches the count of the recording reference counter, as shown at a timing of “n−5” of the recording reference timer, the CPU 109 returns the tape running speed of the video tape VT_{R} to the normal speed in the recording VTR 20, makes the recording VTR 20 start recording the processed material data at a timing of “n” of the time code of the recording VTR 20, and starts reading the video data D_{RV} from the video memory 104, in the program-play apparatus 100.

The program-play apparatus 100 repeatedly performs cycles each having pre-rolling, phase adjustment, and program-length extension and reduction, the same number of times as the number of editing blocks to adjust the program length.

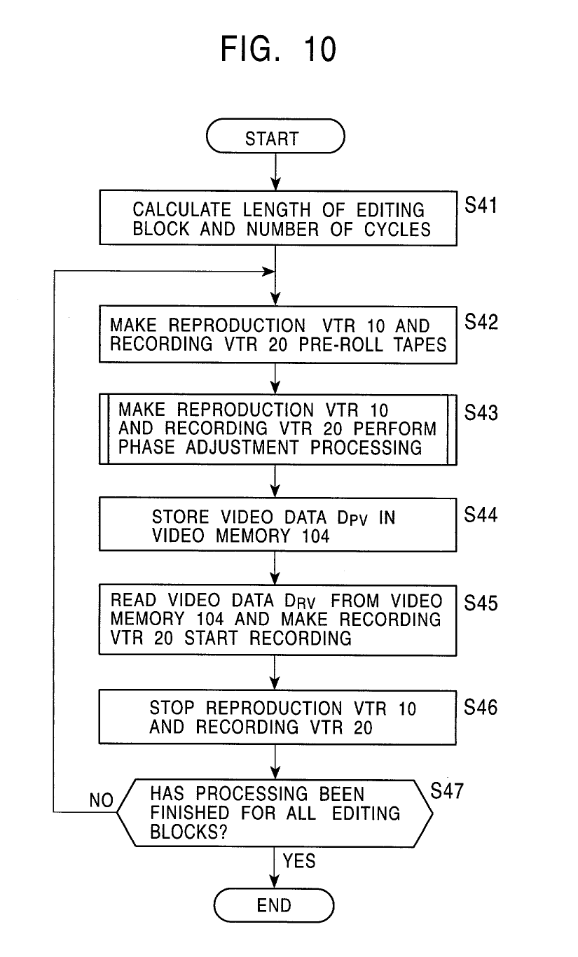

More specifically, in response to pressing of the start button by the user among the operation buttons 119 on the operation panel 118, the program-play apparatus 100 extends or reduces the program length through a series of processes shown in FIG. 10.

As shown in FIG. 10, in the program-play apparatus 100, the CPU 109 calculates the length of the editing block and the number of cycles, described above, according to the program length of the original material data to be reproduced, the program-length extension and reduction rate, and the storage capacity of the video memory 104 in step S41.

Then, in step S42, the program-play apparatus 100 starts editing-block processing under the control of the CPU 109, and outputs control commands CM_{P} and CM_{R a}for instructing pre-rolling to the reproduction VTR 10 and the recording VTR 20 to pre-roll the video tape VT_{P} loaded into the reproduction VTR 10 and the video tape VT_{R} loaded into the recording VTR 20 until a predetermined time before the reproduction start point and the recording start point of a first editing block.

In step S43, when the CPU 109 receives operation-state information INF_{P} and INF_{R} indicating that pre-rolling has been finished, the program-play apparatus 100 starts phase adjustment processing for the reproduction VTR 10 and the recording VTR 20 under the control of the CPU 109.

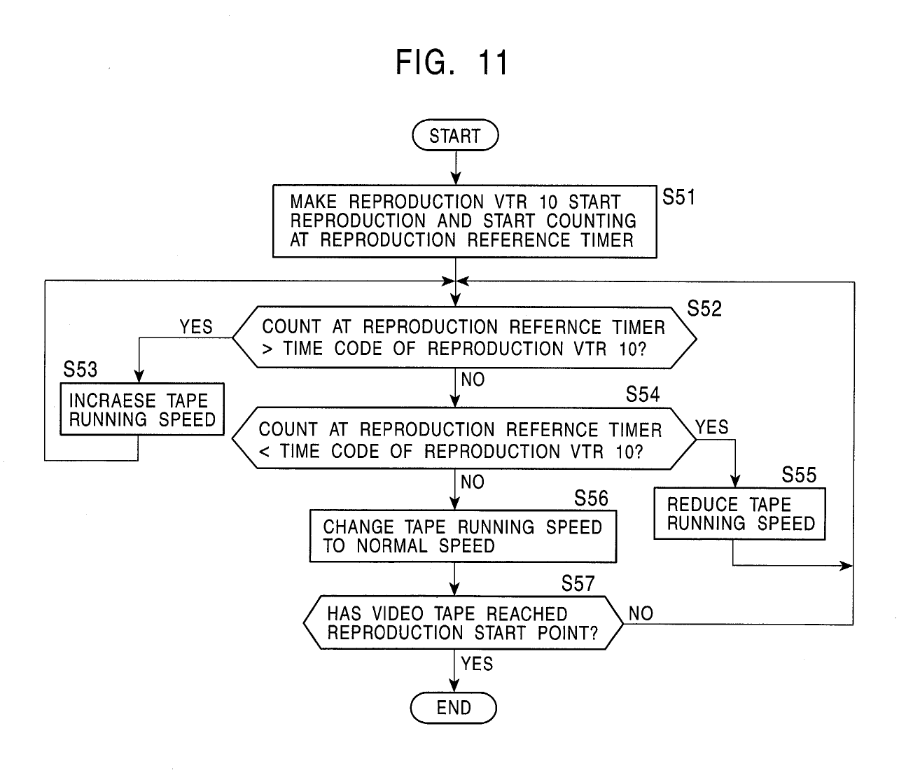

Phase adjustment processing in the reproduction VTR 10 will be performed through a series of processes shown in FIG. 11.

As shown in FIG. 11, the program-play apparatus 100 outputs a control command CM_{P} which instructs the reproduction VTR 10 to start reproduction to start reproduction and starts counting at the reproduction reference timer in step S51 under the control of the CPU 109.

Then, in step S52, the CPU 109 compares the count of the reproduction reference timer with the time code of the reproduction VTR 10 to determine whether the count of the reproduction reference timer is larger than the time code of the reproduction VTR 10, that is, whether the time code of the reproduction VTR 10 goes slower than the count of the reproduction reference timer, in the program-play apparatus 100.

When the time code of the reproduction VTR 10 goes slower than the count of the reproduction reference timer, the program-play apparatus 100 outputs a control command CM_{P} for instructing the reproduction VTR 10 to increase the tape running speed of the video tape VT_{P} by, for example, 10% to increase the tape running speed in step S53 under the control of the CPU 109.

When the time code of the reproduction VTR 10 does not go slower than the count of the reproduction reference timer, the processing proceeds to step S54, and the CPU 109 compares the count of the reproduction reference timer with the time code of the reproduction VTR 10 to determine whether the count of the reproduction reference timer is smaller than the time code of the reproduction VTR 10, that is, whether the time code of the reproduction VTR 10 goes faster than the count of the reproduction reference timer, in the program-play apparatus 100.

When the time code of the reproduction VTR 10 goes faster than the count of the reproduction reference timer, the program-play apparatus 100 outputs a control command CM_{P} for instructing the reproduction VTR 10 to reduce the tape running speed of the video tape VT_{P} by, for example, 10% to reduce the tape running speed in step S55 under the control of the CPU 109. Then, the processing proceeds to step S52.

When the time code of the reproduction VTR 10 does not go faster than the count of the reproduction reference timer, since the count of the reproduction reference timer matches the time code of the reproduction VTR 10, the processing proceeds to step S56 in the program-play apparatus 100. In step S56, the program-play apparatus 100 outputs a control command CM_{P} for instructing the reproduction VTR 10 to return the tape running speed of the video tape VT_{P} to the normal speed to change the tape running speed to the normal speed under the control of the CPU 109.

Then, the program-play apparatus 100 determines in step S57 whether the video tape VT_{P} reaches the reproduction start point in the reproduction VTR 10 according to the time code of the reproduction VTR 10 under the control of the CPU 109.

When the video tape VT_{P} has not yet reached the reproduction start point in the reproduction VTR 10, the processing proceeds to step S52 in the program-play apparatus 100.

On the other hand, when the video tape VT_{P} has reached the reproduction start point in the reproduction VTR 10, the program-play apparatus 100 finishes the series of phase adjustment processing, and returns to step S44 shown in FIG. 10.

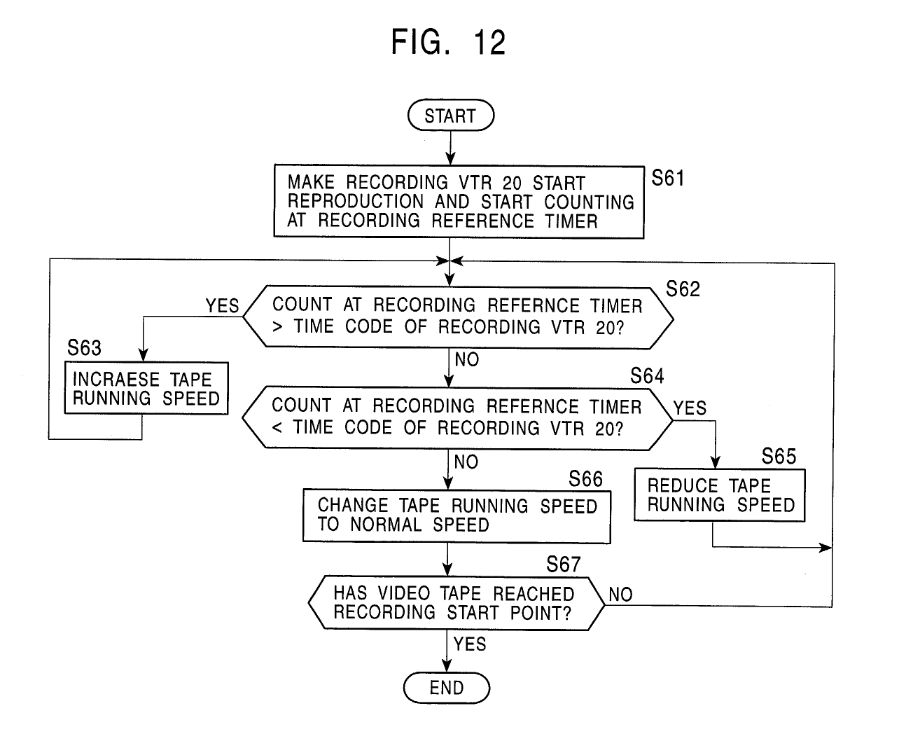

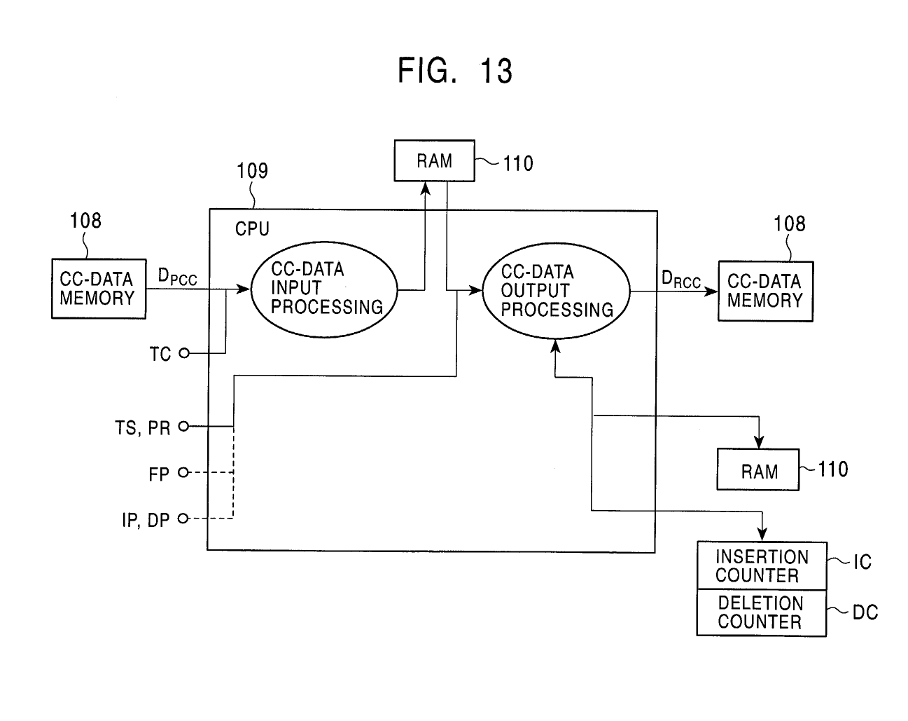

Phase adjustment processing in the recording VTR 20 will be performed through a series of processes shown in FIG. 12.

As shown in FIG. 12, the program-play apparatus 100 outputs a control command CM_{R} which instructs the recording VTR 20 to start reproduction to start reproduction and starts counting at the recording reference timer in step S61 under the control of the CPU 109.

Then, in step S62, the CPU 109 compares the count of the recording reference timer with the time code of the recording VTR 20 to determine whether the count of the recording reference timer is larger than the time code of the recording VTR 20, that is, whether the time code of the recording VTR 20 goes slower than the count of the recording reference timer, in the program-play apparatus 100.

When the time code of the recording VTR 20 goes slower than the count of the recording reference timer, the program-play apparatus 100 outputs a control command CM_{R} for instructing the recording VTR 20 to increase the tape running speed of the video tape VT_{R} by, for example, 10% to increase the tape running speed in step S63 under the control of the CPU 109.

When the time code of the recording VTR 20 does not go slower than the count of the recording reference timer, the processing proceeds to step S64, and the CPU 109 compares the count of the recording reference timer with the time code of the recording VTR 20 to determine whether the count of the recording reference timer is smaller than the time code of the recording VTR 20, that is, whether the time code of the recording VTR 20 goes faster than the count of the recording reference timer, in the program-play apparatus 100.

When the time code of the recording VTR 20 goes faster than the count of the recording reference timer, the program-play apparatus 100 outputs a control command CM_{R} for instructing the recording VTR 20 to reduce the tape running speed of the video tape VTR by, for example, 10% to reduce the tape running speed in step S65 under the control of the CPU 109. Then, the processing proceeds to step S62.

When the time code of the recording VTR 20 does not go faster than the count of the recording reference timer, since the count of the recording reference timer matches the time code of the recording VTR 20, the processing proceeds to step S66 in the program-play apparatus 100. In step S66, the program-play apparatus 100 outputs a control command CM_{R} for instructing the recording VTR 20 to return the tape running speed of the video tape VT_{R} to the normal speed to change the tape running speed to the normal speed under the control of the CPU 109.

Then, the program-play apparatus 100 determines in step S67 whether the video tape VT_{R} reaches the recording start point in the recording VTR 20 according to the time code of the recording VTR 20 under the control of the CPU 109.

When the video tape VT_{R} has not yet reached the recording start point in the recording VTR 20, the processing proceeds to step S62 in the program-play apparatus 100.

On the other hand, when the video tape VT_{R} has reached the recording start point in the recording VTR 20, the program-play apparatus 100 finishes the series of phase adjustment processing, and returns to step S44 shown in FIG. 10.

After the program-play apparatus 100 makes the reproduction VTR 10 and the recording VTR 20 perform the above phase adjustment processing in step S43 shown in FIG. 10 under the control of the CPU 109, the program-play apparatus 100 starts storing the video data D_{PV} in the video memory 104 under the control of the CPU 109 in step S44.

Then, in step S45, the program-play apparatus 100 starts reading the video data D_{RV} from the video memory 104, and outputs a control command CM_{R} for instructing the recording VTR 20 to start recording to start recording, under the control of the CPU 109.

Then, in step S46, when the CPU 109 receives operation-state information INF_{P} and INF_{R} indicating that the video tape VT_{P} in the reproduction VTR 10 and the video tape VT_{R} in the recording VTR 20 have reached the reproduction end point and the recording end point, the program-play apparatus 100 outputs control commands CM_{P} and CM_{R} for instructing the reproduction VTR 10 and the recording VTR 20 to stop reproduction and to stop recording to stop the operations under the control of the CPU 109.

The program-play apparatus 100 determines in step S47 whether the processing has been finished for all editing blocks.

When the processing has not yet been finished for all editing blocks, the processing proceeds to step S42, and the program-play apparatus 100 repeats the processing for the remaining editing blocks. When the processing has been finished for all the editing blocks, the program-play apparatus 100 finishes the series of processes.

Through the above-described processes, the program-play apparatus 100 performs the program-length extension and reduction processing.

In the program-length extension and reduction processing, the program-play apparatus 100 inserts or deletes null data, described above, as CC data according to the program-length extension and reduction rate, as described above, to generate new CC data D_{RCC} corresponding to the video data D_{RV} and the audio data D_{RA}. Processing for generating the new CC data D_{RCC} will be described below.

Under the control of the CPU 109, the program-play apparatus 100 inserts or deletes null data at a frame or a field where overlap reading or skip reading is performed. Line-21 data includes character-information data and a control code, as described above. Character-information data is independently superposed in each field. A control code may be superposed, for example, only in the first field in some cases. The program-play apparatus 100 inserts or deletes null data under the control of the CPU 109 so as not to mix data corresponding to different fields. In addition, based on the same reason, the program-play apparatus 100 inserts or deletes null data under the control of the CPU 109 so that the sequence relationship between the first field and the second field of the CC data D_{RCC} in the processed material data is equal to the sequence relationship between the first field and the second field of the CC data D_{PCC} in the original material data.

More specifically, in the program-play apparatus 100, the CPU 109 executes a software module having a structure shown in FIG. 13. In FIG. 13, only a module indicating a function for inserting and deleting CC data is shown among the functions of the CPU 109. Therefore, in the program-play apparatus 100, a module for controlling the module which inserts and deletes CC data, which is a function of the CPU 109, is substantially a function of the CPU 109, and is hereinafter called a “higher module.”

As shown in FIG. 13, the CPU 109 first reads the CC data D_{PCC} stored in the CC-data memory 108 serving as a CC-data input buffer, and performs CC-data D_{PCC} input processing. The CPU 109 receives current-time information TC together with the CC data D_{PCC}. The current-time information TC is relative time information indicating the time when the CC data D_{PCC} is input, and is generated by the CPU 109 spontaneously. In other words, the CPU 109 gives the current-time information TC generated by the higher module serving as current-time-information generation means to the module, and functions as data input (taking-in) means for associating the information with the CC data D_{PCC} and receiving the CC data. The CPU 109 writes the received CC data D_{PCC} and the current-time information TC into the RAM 110 serving as a CC-data-input storage area, for temporary storage through the bus 113.

The CPU 109 also functions as data output means for outputting the CC data received in this way, and performs the following output processing. When the CPU 109 receives reading-start-time information TS from a higher module serving as reading-start-time generation means, the CPU 109 writes the reading-start-time information TS in the RAM 110 serving as a reading-start-time information storage area, through the bus 113 for temporary storage. The reading-start-time information TS is generated by the CPU 109 spontaneously, as the current-time information TC is generated, and the reading-start-time information TS is relative time information indicating the time when the received CC data D_{PCC} is read. When the CPU 109 receives processing-method request information PR from a higher module serving as processing-method-request-information generation means, the CPU 109 writes the processing-method request information PR in the RAM 110 functioning as a processing-method flag storage area for temporary storage. The processing-method request information PR indicates whether an image constituting video data is inserted or deleted in units of frames or fields in order to extend or reduce the program length. Then, the CPU 109 sequentially writes the CC data D_{PCC} stored in the RAM 110 serving as the CC-data input storage area and associated with the time corresponding to the reading-start-time information TS, in the CC-data memory 108 serving as the CC-data output buffer as CC data D_{RCC} by the use of regular frame pulses FP sent from a higher module serving as frame-pulse generation means. When a higher module serving as insertion-pulse or reduction-pulse generation means sends an insertion pulse IP or a reduction pulse DP indicating that null data is inserted or deleted into or from the CC data D_{RCC}, to the CPU 109, the CPU 109 starts a process for inserting or deleting null data into or from the CC data D_{RCC} to be output, and activates an insertion counter IC or a deletion counter DC provided for the CPU 109.

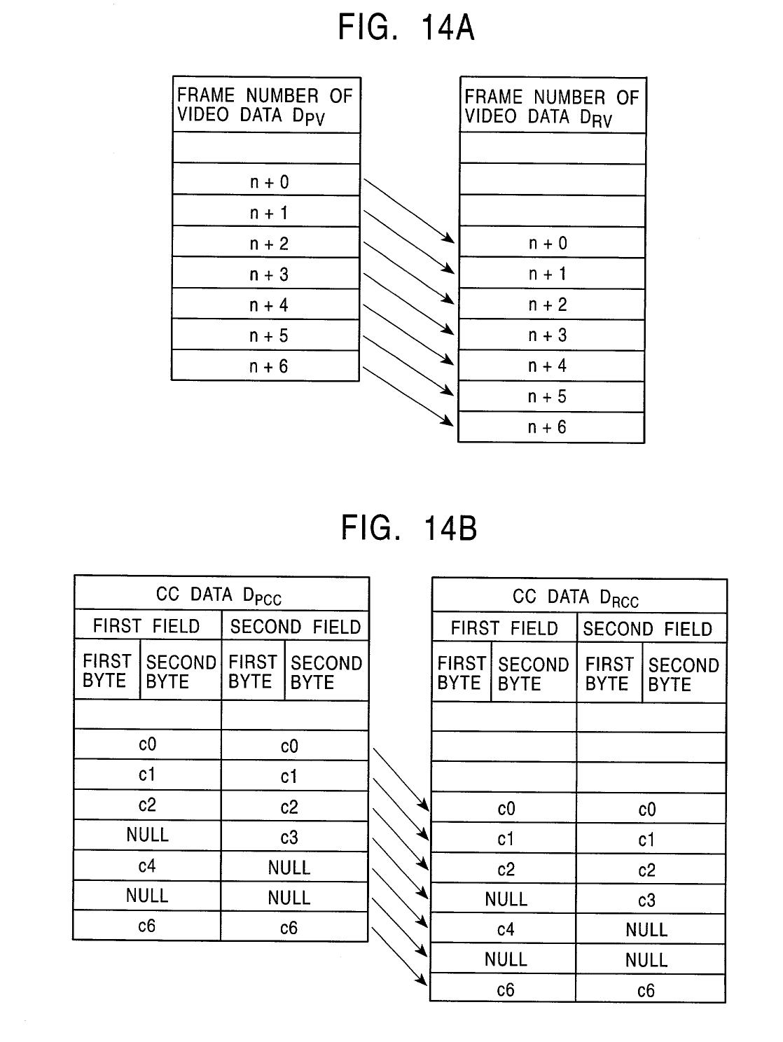

Such CC-data D_{RCC} output processing will be described more specifically below by referring to FIG. 14 to FIG. 20.

A case in which a frame is not inserted or deleted into or from the video data D_{PV} stored in the video memory 104 will be described first.

It is assumed, for example, that video data D_{PV} having frame numbers of n+0, n+1, n+2, n+3, n+4, n+5, and n+6 is input into the video memory 104, as shown at the left-hand side of FIG. 14A. It is also assumed that, in reproduction data D_{P}, CC data D_{PCC} formed of (c0, c0), (c1, c1), (c2, c2), (NULL, c3), (c4, NULL), (NULL, NULL), and (c6, c6), where first items in the parentheses correspond to the first field, and second items in the parentheses correspond to the second field, as shown in the left-hand side of FIG. 14B, is superposed in the corresponding frames of the video data D_{PV} and the CC data D_{PCC} is stored in the CC-data memory 108. In FIG. 14B, “a first byte” and “a second byte” in each field indicate the character one section where the first character is recorded and the character two section where the second character is recorded, described above, and “NULL” indicates that null data, described above, is superposed.

In this case, after a predetermined time elapses, the program-play apparatus 100 reads video data from the video memory 104 under the control of the CPU 109 as video data D_{RV} having frame numbers of n+0, n+1, n+2, n+3, n+4, n+5, and n+6 without changing the frame sequence relationship, as shown at the right-hand side of FIG. 14A. The frame numbers indicate the reading-start-time information TS.

In response to this reading, after a predetermined time elapses, the program-play apparatus 100 reads CC data from the CC-data memory 108 under the control of the CPU 109 as CC data D_{RCC} formed of (c0, c0), (c1, c1), (c2, c2), (NULL, c3), (c4, NULL), (NULL, NULL), and (c6, c6) without changing the frame sequence relationship, corresponding to the video data, as shown at the right-hand side of FIG. 14B.

When a frame is not inserted or deleted into and from video data D_{PV} stored in the video memory 104, the program-play apparatus 100 controls such that the phase relationship between the video data D_{RV} and CC data D_{RCC} to be output is maintained at that between the input video data D_{PV} and CC data D_{PCC}, and outputs the video data D_{RV} and CC data D_{RCC}, under the control of the CPU 109.

A case in which an image is deleted in units of frames from the video data D_{PV} stored in the video memory 104 will be described next.

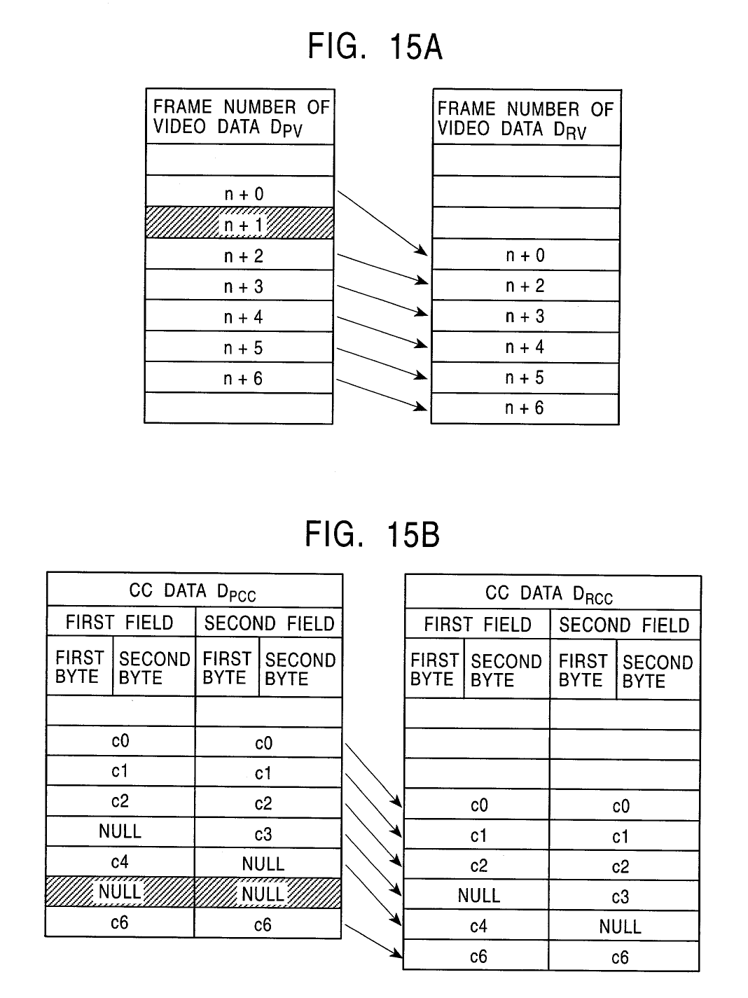

It is assumed, for example, that video data D_{PV} having frame numbers of n+0, n+1, n+2, n+3, n+4, n+5, and n+6 is input into the video memory 104, as shown at the left-hand side of FIG. 15A, and the (n+1)-th frame hatched in FIG. 15A is deleted by skip reading. It is also assumed that, in reproduction data D_{P}, CC data D_{PCC}, formed of (c0, c0), (c1, c1), (c2, c2), (NULL, c3), (c4, NULL), (NULL, NULL), and (c6, c6), where first items in the parentheses correspond to the first field, and second items in the parentheses correspond to the second field, as shown in the left-hand side of FIG. 15B, is superposed in the corresponding frames of the video data D_{PV}, and the CC data D_{PCC} is stored in the CC-data memory 108.

In this case, under the control of the CPU 109, the program-play apparatus 100 deletes the (n+1)-th frame, and after a predetermined time elapses, reads video data from the video memory 104 as video data D_{RV} having frame numbers of n+0, n+2, n+3, n+4, n+5, and n+6 without changing the sequence relationship of the remaining frames, as shown at the right-hand side of FIG. 15A.

In response to this reading, under the control of the CPU 109, the program-play apparatus 100 deletes CC data D_{PCC} having “NULL” in both the first and second fields for the first time in the (n+1)-th frame, for which the video data D_{PV} was deleted, and the subsequent frames, that is, the CC data D_{PCC} corresponding to the (n+5)-th frame hatched in FIG. 15B, and, after a predetermined time elapses, reads CC data from the CC-data memory 108 as CC data D_{RCC} formed of (c0, c0), (c1, c1), (c2, c2), (NULL, c3), (c4, NULL), and (c6, c6) without changing the sequence relationship of the remaining frames, as shown at the right-hand side of FIG. 15B. In other words, the program-play apparatus 100 does not delete CC data D_{PCC} in the two closest fields (the first field in the (n+3)-th frame and the second field in the (n+4)-th frame) having “NULL” in the (n+1)-th frame, for which the video data D_{PV} was deleted, and the subsequent frames, but deletes the CC data D_{PCC} corresponding to the frame having “NULL” in both the first and second fields.

When an image is deleted in units of frames from video data D_{PV} stored in the video memory 104, the program-play apparatus 100 deletes CC data D_{PCC} having “NULL” in both the first and second fields, the same number of times as that of frames deleted from the video data D_{PV}, and outputs the video data D_{RV} and CC data D_{RCC}, under the control of the CPU 109. In other words, the program-play apparatus 100 deletes null data under the control of the CPU 109 such that data corresponding to different fields is not mixed although a control code is superposed only in one of two fields, and such that the sequence relationship between CC data D_{RCC} in the first field and second field, of the processed material data is not different from that between the CC data D_{PCC} in the first field and second field, of the original material data.

A case in which an image is inserted in units of frames into the video data D_{PV} stored in the video memory 104 will be described next.

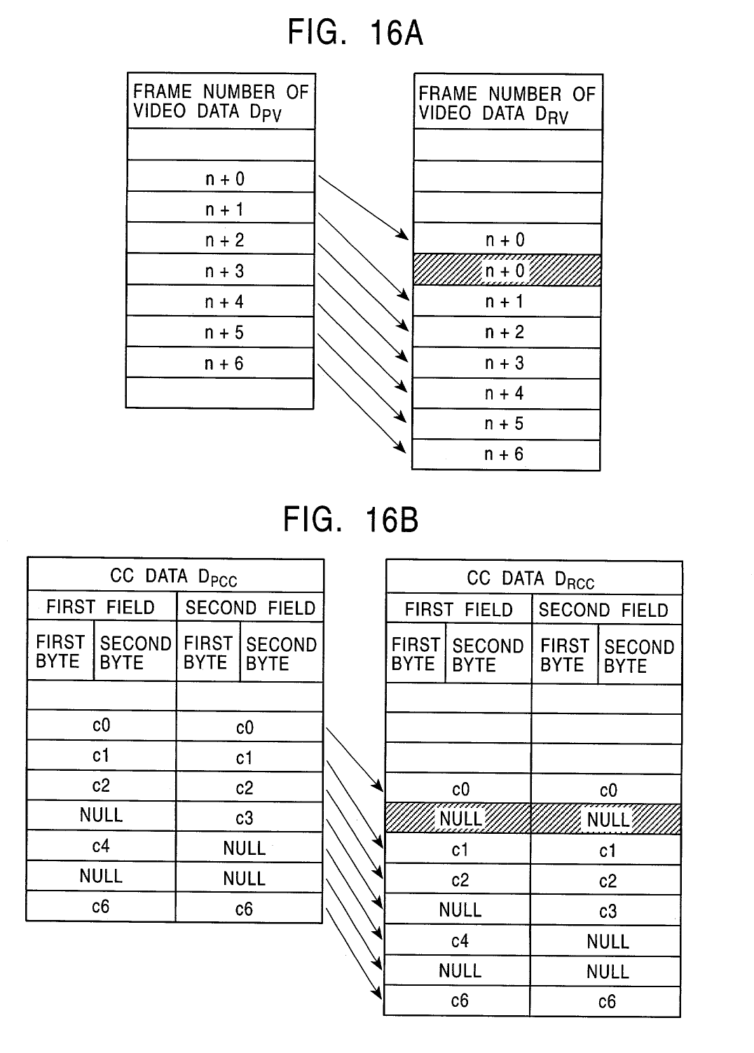

It is assumed, for example, that video data D_{PV} having frame numbers of n+0, n+1, n+2, n+3, n+4, n+5, and n+6 is input into the video memory 104, as shown at the left-hand side of FIG. 16A, and the (n+0)-th frame hatched in FIG. 16A is inserted by overlap reading. It is also assumed that, in reproduction data D_{P}, CC data D_{PCC} formed of (c0, c0), (c1, c1), (c2, c2), (NULL, c3), (c4, NULL), (NULL, NULL), and (c6, c6), where first items in the parentheses correspond to the first field, and second items in the parentheses correspond to the second field, as shown in the left-hand side of FIG. 16B, is superposed in the corresponding frames of the video data D_{PV}, and the CC data D_{PCC} is stored in the CC-data memory 108.

In this case, under the control of the CPU 109, the program-play apparatus 100 inserts the (n+0)-th frame, and after a predetermined time elapses, reads video data from the video memory 104 as video data D_{RV} having frame numbers of n+0, n+0, n+1, n+2, n.+3, n+4, n+5, and n+6 without changing the sequence relationship of the remaining frames, as shown at the right-hand side of FIG. 16A.

In response to this reading, under the control of the CPU 109, the program-play apparatus 100 inserts CC data D_{PCC} having “NULL” in both the first and second fields hatched in FIG. 16B immediately after the (n+0)-th frame, correspondingly to the video data D_{RV} into which the (n+0)-th frame has been inserted, and, after a predetermined time elapses, reads CC data from the CC-data memory 108 as CC data D_{RCC} formed of (c0, c0), (NULL, NULL), (c1, c1), (c2, c2), (NULL, c3), (c4, NULL), (NULL, NULL), and (c6, c6) without changing the sequence relationship of the remaining frames.

When an image is inserted in units of frames into video data D_{PV} stored in the video memory 104, the program-play apparatus 100 inserts CC data D_{PCC} having “NULL” in both the first and second fields, the same number of times as that of frames inserted into the video data D_{PV} and outputs the video data D_{RV} and CC data D_{RCC}, under the control of the CPU 109. In other words, the program-play apparatus 100 inserts null data under the control of the CPU 109 such that data corresponding to different fields is not mixed although a control code is superposed only in one of two fields, and such that the sequence relationship between CC data D_{RCC} in the first field and second field, of the processed material data is not different from that between CC data D_{PCC} in the first field and second field, of the original material data.

A case in which an image is deleted in units of fields from the video data D_{PV} stored in the video memory 104 will be described next.

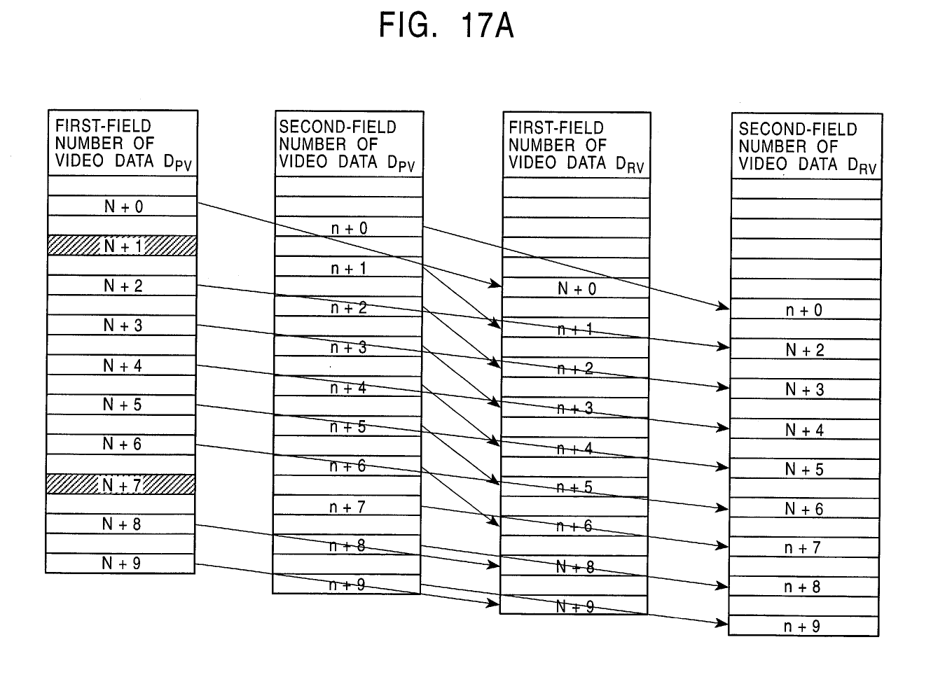

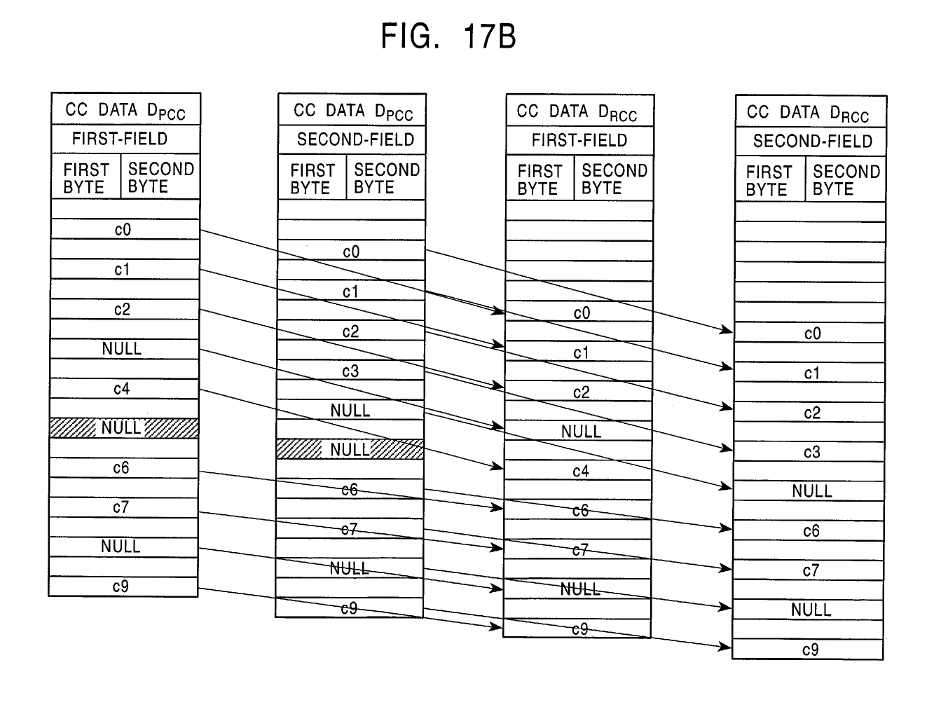

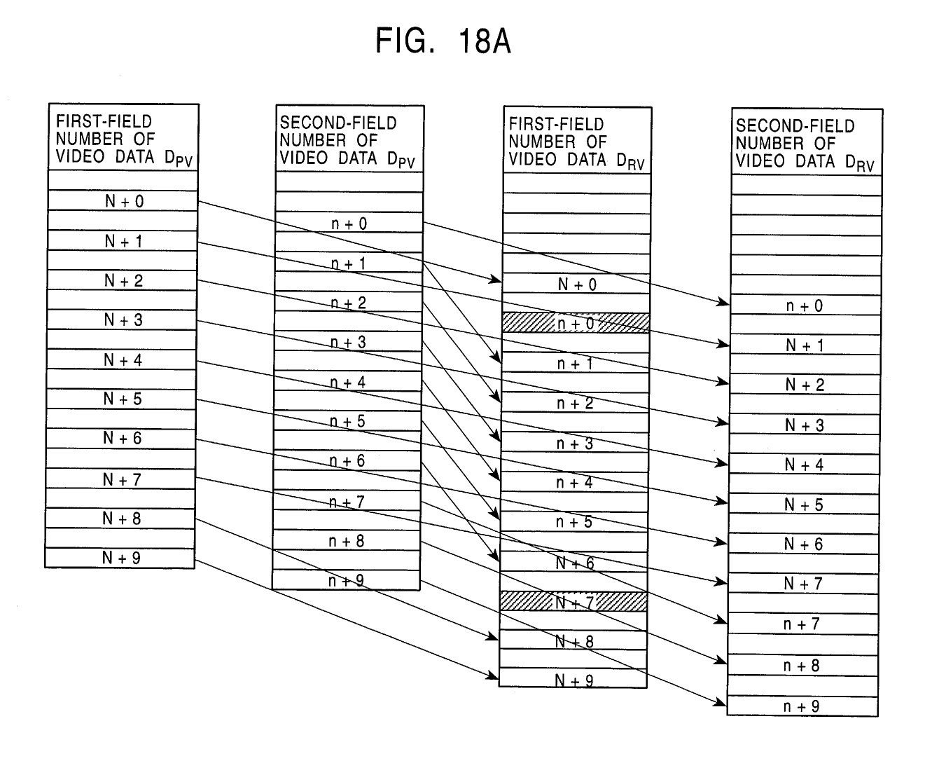

It is assumed, for example, that video data D_{PV} having field numbers of N+0, n+0, N+1, n+1, N+2, n+2, N+3, n+3, N+4, n+4, N+5, n+5, N+6, n+6, N+7, n+7, N+8, n+8, N+9, and n+9, that is, video data D_{PV} having frame numbers of n+0, n+1, n+2, n+3, n+4, n+5, n+6, n+7, n+8, and n+9, is input into the video memory 104, as shown at the left-hand side of FIG. 17A, and a first field (N+1) in the (n+1)-th frame and a first field (N+7) in the (n+7)-th frame hatched in FIG. 17A are deleted by skip reading. It is also assumed that, in reproduction data D_{P}, CC data D_{PCC} formed of (C0, c0), (C1, c1), (C2, c2), (NULL, c3), (C4, NULL), (NULL, NULL), (C6, c6), (C7, c7), (NULL, NULL), and (C9, c9), where first items in the parentheses correspond to the first field, and second items in the parentheses correspond to the second field, as shown in the left-hand side of FIG. 17B, is superposed on the corresponding frames of the video data D_{PV}, and the CC data D_{PCC} is stored in the CC-data memory 108.

In this case, under the control of the CPU 109, the program-play apparatus 100 deletes the first field (N+1) in the (n+1)-th frame and the first field (N+7) in the (n+7)-th frame, and after a predetermined time elapses, reads video data from the video memory 104 as video data D_{RV} having field numbers of N+0, n+0, n+1, N+2, n+2, N+3, n+3, N+4, n+4, N+5, n+5, N+6, n+6, n+7, N+8, n+8, N+9, and n+9, without changing the sequence relationship of the remaining fields, as shown at the right-hand side of FIG. 17A. In other words, under the control of the CPU 109, the program-play apparatus 100 outputs the video data D_{RV} formed of nine frames, (N+0, n+0), (n+1, N+2), (n+2, N+3), (n+3, N+4), (n+4, N+5), (n+5, N+6), (n+6, n+7), (N+8, n+8), and (N+9, n+9), where first items in the parentheses correspond to the first field, and second items in the parentheses correspond to the second field.

In response to this reading, under the control of the CPU 109, the program-play apparatus 100 deletes CC data D_{PCC} having “NULL” in both the first and second fields in all of 18 fields, that is, the CC data D_{PCC} stored in the first and second fields corresponding to the (n+5)-th frame hatched in FIG. 17B, and, after a predetermined time elapses, reads CC data from the CC-data memory 108 as CC data D_{RCC} formed of (C0, c0), (C1, c1), (C2, c2), (NULL, c3), (C4, NULL), (C6, c6), (C7, c7), (NULL, NULL), and (C9, c9) without changing the sequence relationship of the remaining frames, as shown at the right-hand side of FIG. 17B. In other words, the program-play apparatus 100 does not delete CC data D_{PCC} in the two closest fields (the first field in the (n+3)-th frame and the second field in the (n+4)-th frame) having “NULL” among all the fields, but deletes the CC data D_{PCC} in the frame having “NULL” in both the first and second fields.

When an image is deleted in units of fields from video data D_{PV} stored in the video memory 104, the program-play apparatus 100 deletes CC data D_{PCC} having “NULL” in both the first and second fields, the same number of times as that of fields deleted from the video data D_{PV}, and outputs the video data D_{RV} and CC data D_{RCC}, under the control of the CPU 109. In other words, the program-play apparatus 100 deletes null data under the control of the CPU 109 such that data corresponding to different fields is not mixed although a control code is superposed only in one of two fields, and such that the sequence relationship between CC data D_{RCC} in the first field and second field, of the processed material data is not different from that between CC data D_{PCC} in the first field and second field, of the original material data.

A case in which an image is inserted in units of fields into the video data D_{PV} stored in the video memory 104 will be described next.

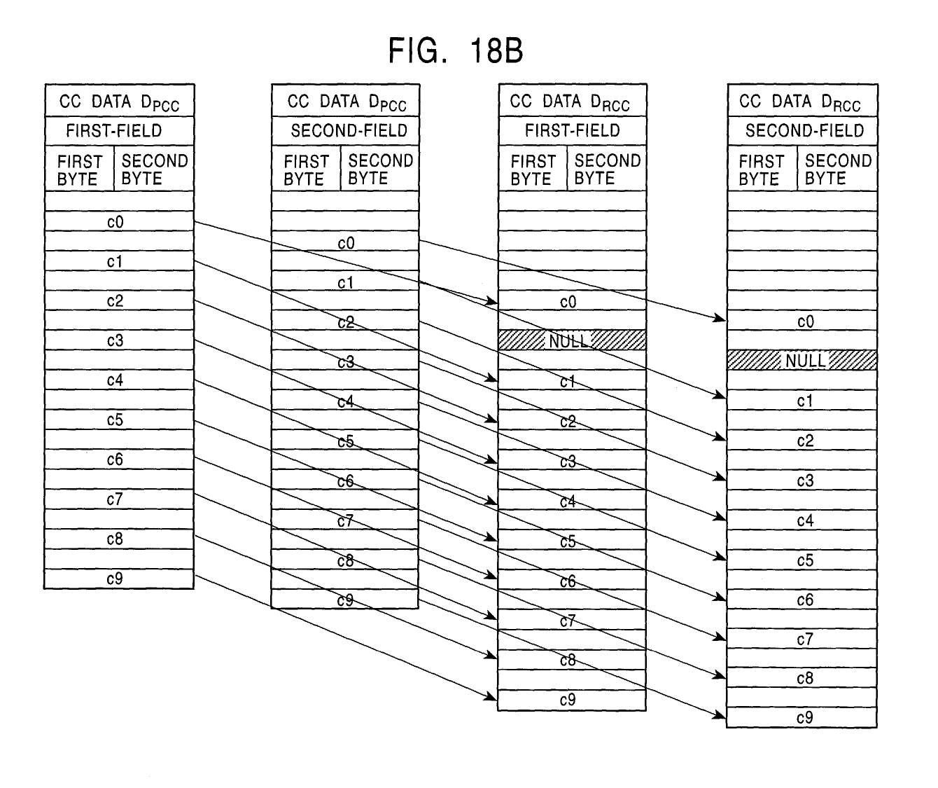

It is assumed, for example, that video data D_{PV} having field numbers of N+0, n+0, N+1, n+1, N+2, n+2, N+3, n+3, N+4, n+4, N+5, n+5, N+6, n+6, N+7, n+7, N+8, n+8, N+9, and n+9, that is, video data D_{PV} having frame numbers of n+0, n+1, n+2, n+3, n+4, n+5, n+6, n+7, n+8, and n+9, is input into the video memory 104, as shown at the left-hand side of FIG. 18A, and a second field (n+0) in the (n+0)-th frame and a first field (N+7) in the (n+7)-th frame hatched in FIG. 18A are inserted by overlap reading. It is also assumed that, in reproduction data D_{P}, CC data D_{PCC} formed of (C0, c0), (C1, c1), (C2, c2), (C3, c3), (C4, c4), (C5, c5), (C6, c6), (C7, c7), (C8, c8), and (C9, c9), where first items in the parentheses correspond to the first field, and second items in the parentheses correspond to the second field, as shown in the left-hand side of FIG. 18B, is superposed in the corresponding frames of the video data D_{PV}, and the CC data D_{PCC} is stored in the CC-data memory 108.

In this case, under the control of the CPU 109, the program-play apparatus 100 inserts the second field (n+0) in the (n+0)-th frame and the first field (N+7) in the (n+7)-th frame, and after a predetermined time elapses, reads video data from the video memory 104 as video data D_{RV} having field numbers of N+0, n+0, n+0, N+1, n+1, N+2, n+2, N+3, n+3, N+4, n+4, N+5, n+5, N+6, n+6, N+7, N+7, n+7, N+8, n+8, N+9, and n+9, without changing the sequence relationship of the remaining fields, as shown at the right-hand side of FIG. 18A. In other words, under the control of the CPU 109, the program-play apparatus 100 outputs the video data D_{RV} formed of 11 frames, (N+0, n+0), (n+0, N+1), (n+1, N+2), (n+2, N+3), (n+3, N+4), (n+4, N+5), (n+5, N+6), (n+6, n+7), (N+7, n+7), (N+8, n+8), and (N+9, n+9), where first items in the parentheses correspond to the first field, and second items in the parentheses correspond to the second field.

In response to this reading, under the control of the CPU 109, the program-play apparatus 100 inserts CC data D_{PCC} having “NULL” in both the first and second fields, hatched in FIG. 18B, into the frame immediately after the (n+0)-th frame, correspondingly to the vide data D_{RV} in which the second field (n+0) in the (n+0)-th frame and the first field (N+7) in the (n+7)-th frame has been inserted, and, after a predetermined time elapses, reads CC data from the CC-data memory 108 as CC data D_{RCC} formed of (C0, c0), (NULL, NULL), (C1, c1), (C2, c2), (C3, c3), (C4, c4), (C5, c5), (C6, c6), (C7, c7), (C8, c8), and (C9, c9) without changing the sequence relationship of the remaining frames, as shown at the right-hand side of FIG. 18B.

When an image is inserted in units of fields into video data D_{PV} stored in the video memory 104, the program-play apparatus 100 inserts CC data D_{RCC} having “NULL” in both the first and second fields, the same number of times as that of fields inserted into the video data D_{PV}, and outputs the video data D_{RV} and CC data D_{RCC}, under the control of the CPU 109. In other words, the program-play apparatus 100 inserts null data under the control of the CPU 109 such that data corresponding to different fields is not mixed although a control code is superposed only in one of two fields, and such that the sequence relationship between the CC data D_{RCC} in the first field and second field, of the processed material data is not different from that between CC data D_{PCC} in the first field and second field, of the original material data.

When null data is inserted in units of fields or frames, the program-play apparatus 100 inserts CC data D_{RCC} having NULL in both the first and second fields immediately after a deleted frame or field, as described above. This method may cause the following problem.

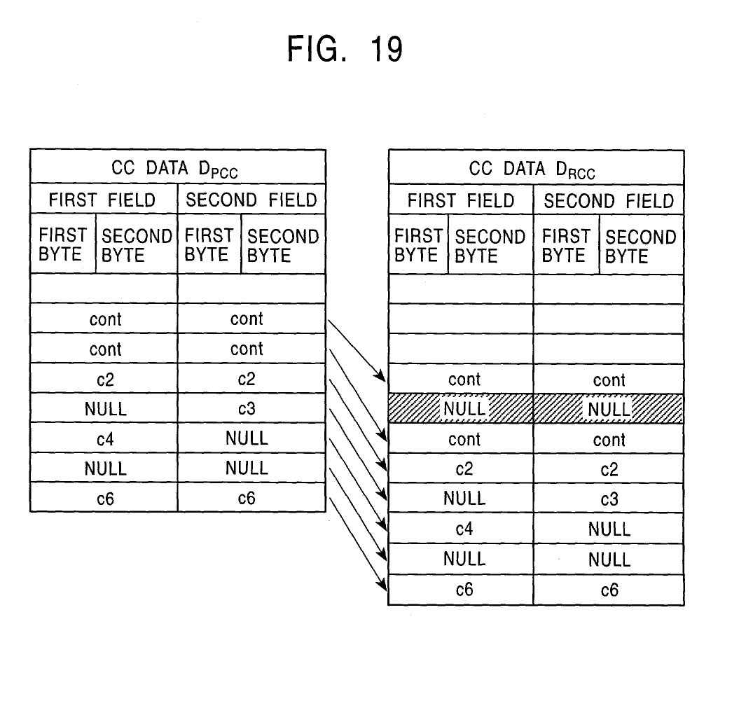

The line-21 data includes character-information data and a control code, as described above. In Line 21 Data Services, a control code is superposed in consecutive two frames. In other words, in Line 21 Data Services, the identical control codes are superposed in two consecutive frames, such that, for example, CC data D_{PCC} formed of (control code (cont), control code (cont)), (control code (cont), control code (cont)), (c2, c2), (NULL, c3), (c4, NULL), (NULL, NULL), and (c6, c6), where first items in the parentheses correspond to the first field, and second items in the parentheses correspond to the second field, is superposed on the corresponding frames of video data D_{PV} in reproduction data DP, as shown at the left-hand side of FIG. 19.

In this case, when null data is inserted in units of frames or fields in the above-described method, CC data D_{RCC} having NULL in both the first and second fields, hatched in FIG. 19, may be inserted between the (n+0)-th frame and the (n+1)-th frame of the original material data, as shown at the right-hand side of FIG. 19. This separates the control codes. Many units for reproducing processed material data, such as TV sets, for example, include a CC decoder formed of a commercial integrated circuit. Therefore, when the units reproduce processed material data in which the CC data D_{RCC} has been inserted, the CC decoder may malfunction due to the separation of control codes, and character information may be inappropriately displayed.

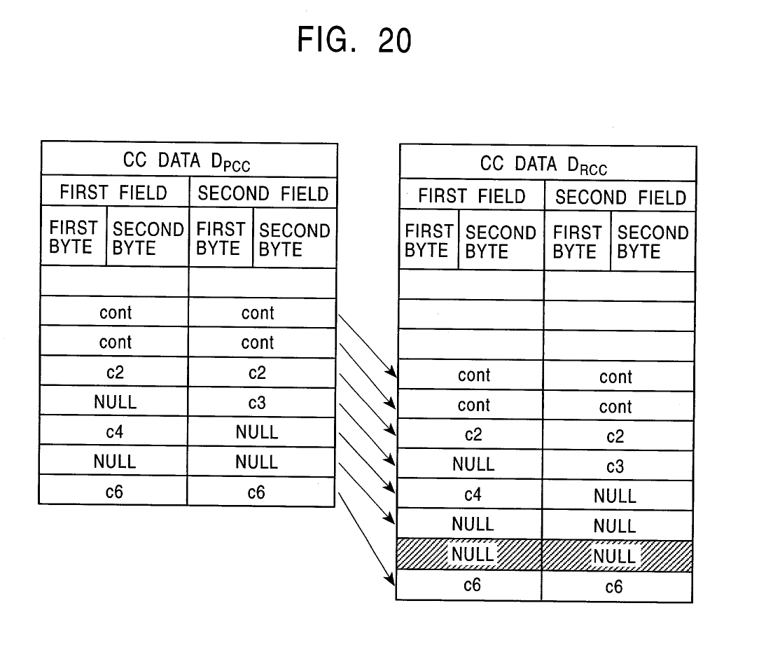

To solve this problem, the program-play apparatus 100 inserts CC data D_{RCC} having NULL in both the first and second fields immediately after CC data D_{PCC} having NULL in both the first and second fields of the original material data. Specifically, when CC data D_{PCC} formed of (control code (cont), control code (cont)), (control code (cont), control code (cont)), (c2, c2), (NULL, c3), (c4, NULL), (NULL, NULL), and (c6, c6), where first items in the parentheses correspond to the first field, and second items in the parentheses correspond to the second field, is superposed on the corresponding frames of video data D_{PV} in reproduction data D_{P}, as shown at the left-hand side of FIG. 20, the program-play apparatus 100 inserts CC data D_{RCC} having NULL in both the first and second fields, hatched in FIG. 20, immediately after the (n+5)-th frame of the original material data, in which CC data D_{PCC} having NULL in both the first and second fields has been superposed, as shown at the right-hand side of FIG. 20.

When the program-play apparatus 100 inserts null data under such a condition, the structure of CC data D_{RCC} in processed material data is closest to that of CC data D_{PCC} in the original material data, and character information can be displayed appropriately even with existing CC decoders.

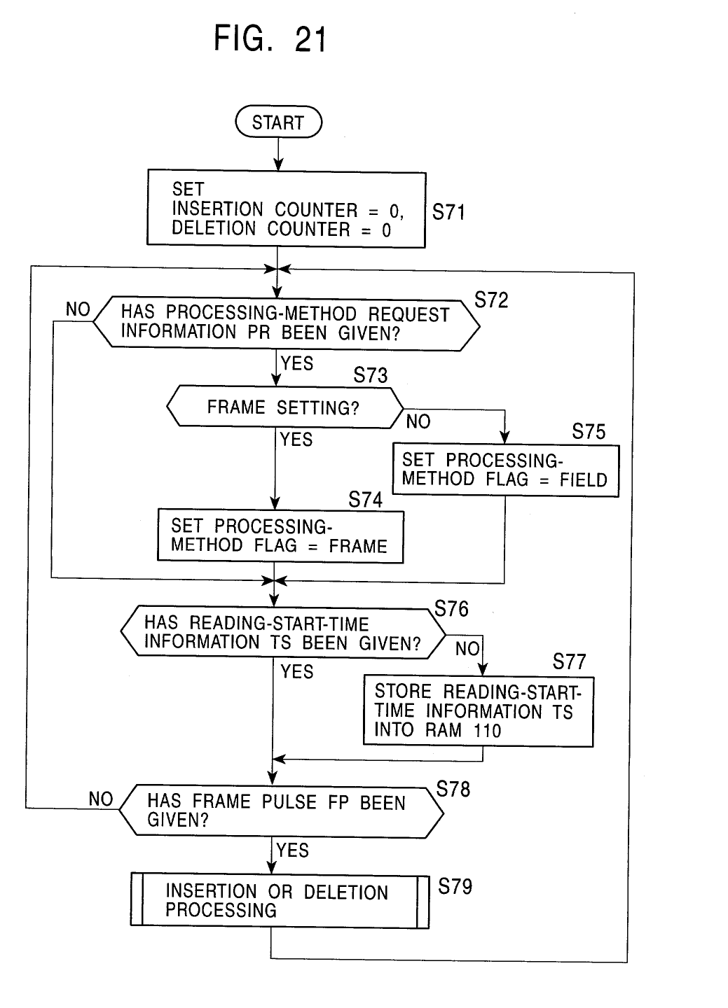

In the program-play apparatus 100, which inserts or deletes CC data in units of frames or fields in the foregoing way, the CPU 109 performs CC-data output processing through a series of processes shown in FIG. 21.

As shown in FIG. 21, the CPU 109 first initializes the counts of the insertion counter IC and the deletion counter DC, described above, to zero in step S71.

Then, the CPU 109 determines in step S72 whether processing-method request information PR has been given from a higher module.

When the CPU 109 determines that processing-method request information PR has not been given, the processing proceeds to step S76.

When the CPU 109 determines that processing-method request information PR has been given, the CPU 109 determines in step S73 whether the processing-method request information PR specifies a frame setting which indicates that an image constituting video data is inserted or deleted in units of frames.

When it is determined that the processing-method request information PR specifies a frame setting, the CPU 109 sets a processing-method flag to “frame,” and writes it into the RAM 110 serving as a processing-method-flag storage area, for temporary storage, and the processing proceeds to step S76.

When it is determined that the processing-method request information PR does not specify a frame setting, in other words, that the processing-method request information PR specifies a field setting which indicates that an image constituting video data is inserted or deleted in units of fields, the CPU 109 sets the processing-method flag to “field,” and writes it into the RAM 110 serving as the processing-method-flag storage area, for temporary storage, and the processing proceeds to step S76.

Then, in step S76, the CPU 109 determines whether reading-start-time information TS has been given from a higher module.

When the CPU determines that the reading-start-time information TS has not been given, the processing proceeds to step S78.

When it is determined that the reading-start-time information TS has been given, the CPU 109 writes the reading-start-time information TS into the RAM 110 serving as a reading-start-time-information storage area, for temporary storage, and the processing proceeds to step S78.

Then, in step S78, the CPU 109 determines whether a frame pulse FP has been given from a higher module.

When the CPU 109 determines that a frame pulse FP has not been given, the processing proceeds to step S72.

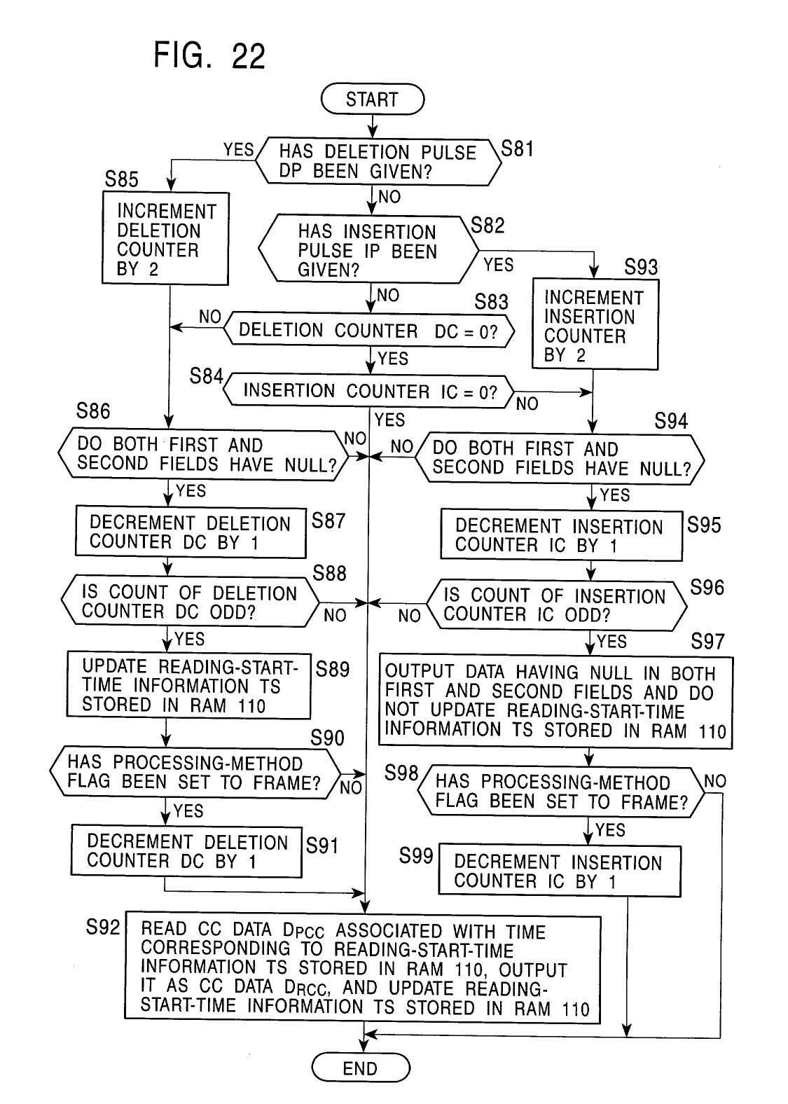

When it is determined that a frame pulse FP has been given, the CPU 109 performs CC-data insertion or deletion processing in step S79. The CC-data insertion or deletion processing is expressed by a series of processes shown in FIG. 22.

As shown in FIG. 22, in step S81, the CPU 109 determines whether a deletion pulse DP has been given from a higher module.

When the CPU 109 determines that a deletion pulse DP has been given, the processing proceeds to deletion processing starting at step S85 and ending at step S92.

When it is determined that a deletion pulse DP has not been given, the CPU 109 determines in step S82 whether an insertion pulse IP has been given from a higher module.

When the CPU determines that an insertion pulse IP has been given, the processing proceeds to insertion processing starting at step S93 and ending at step S99.

When it is determined that an insertion pulse has not been given, the CPU 109 determines in step S83 whether the count of the deletion counter DC is zero.

When the CPU 109 determines that the count of the deletion counter DC is not zero, the processing proceeds to step S86.

When it is determined that the count of the deletion counter DC is zero, the CPU 109 determines in step S84 whether the count of the insertion counter IC is zero.

When the CPU 109 determines that the count of the insertion counter IC is not zero, the processing proceeds to step S94.

When it is determined that the count of the insertion counter IC is zero, the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as a CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined in step S81 shown in FIG. 22 that a deletion pulse DP has been given, the CPU 109 performs the deletion processing starting at step S85 and ending at step S92. In step S85, the CPU 109 increments the count of the deletion counter DC by 2.

Then, in step S86, the CPU 109 determines whether both the first and second fields have null data (NULL).

When it is determined that the first field and the second field do not have null data, the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined that both the first and second fields have null data, the CPU 109 decrements the count of the deletion counter DC by 1 in step S87 shown in FIG. 22.

Then, in step S88, the CPU 109 determines whether the count of the deletion counter DC is odd.

When it is determined that the count of the deletion counter DC is not odd, that is, that the count is even, the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined that the count of the deletion counter DC is odd, the CPU 109 updates the reading-start-time information TS stored in the RAM 110 to the next time information so as not to output null data, in step S89 shown in FIG. 22.

Then, in step S90, the CPU 109 determines whether the processing-method flag stored in the RAM 110 serving as the processing-method-flag storage area has been set to “frame.”

When it is determined that the processing-method flag has not been set to “frame,” the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined that the processing-method flag has been set to “frame,” the CPU 109 decrements the count of the deletion counter DC by 1, in step S91 shown in FIG. 22.

Then, the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined in step S82 shown in FIG. 22 that an insertion pulse IP has been given, the CPU 109 performs the insertion processing starting at step S93 and ending at step S99. In step S93, the CPU 109 increments the count of the insertion counter IC by 2.

Then, in step S94, the CPU 109 determines whether both the first and second fields have null data (NULL).

When it is determined that the first field and the second field do not have null data, the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined that both the first and second fields have null data, the CPU 109 decrements the count of the insertion counter IC by 1 in step S95 shown in FIG. 22.

Then, in step S96, the CPU 109 determines whether the count of the insertion counter IC is odd.

When it is determined that the count of the insertion counter IC is not odd, that is, that the count is even, the processing proceeds to step S92, and the CPU 109 reads the CC data D_{PCC} associated with the time corresponding to the reading-start-time information TS stored in the RAM 110 serving as the reading-start-time-information storage area, from the RAM 110, and outputs it as CC data D_{RCC} to the CC-data memory 108 serving as the CC-data output buffer. Then, the CPU 109 updates the reading-start-time information TS stored in the RAM 110 to the next time information, and the series of insertion or deletion processes is terminated. When the insertion or deletion processing is terminated, the CC-data output processing proceeds to step S72 shown in FIG. 21, and the same processes are repeated.

When it is determined that the count of the insertion counter IC is odd, the CPU 109 outputs CC data D_{RCC} having null data in both the first and second fields to the CC-data memory 108 serving as the CC-data output buffer in step S97 shown in FIG. 22. The CPU does not update the reading-start-time information TS stored in the RAM 110 so as to output the data which should have been output in this frame, in the next frame.

Then, in step S98, the CPU 109 determines whether the processing-method flag stored in the RAM 110 serving as the processing-method-flag storage area has been set to “frame.”

When it is determined that the processing-method flag has not been set to “frame,” the CPU 109 terminates the series of insertion or deletion processes. When the insertion or deletion processing is terminated, the CC-data output processing proceeds to step S72 shown in FIG. 21, and the same processes are repeated.

When it is determined that the processing-method flag has been set to “frame,” the CPU 109 decrements the count of the insertion counter DC by 1, in step S99 shown in FIG. 22. The CPU 109 terminates the series of insertion or deletion processes. When the insertion or deletion processing is terminated, the CC-data output processing proceeds to step S72 shown in FIG. 21, and the same processes are repeated.

As described above, the program-play apparatus 100 inserts or deletes CC data in units of frames or fields through the CC-data output processing executed by the CPU 109.

As described above, in the program-length adjustment system 1 according to an embodiment of the present invention, when the program-play apparatus 100 extends or reduces the program length of reproduction data obtained by reproducing the original material data on which CC data, which is program-accompanying data that accompanies the program, has been superposed, not data which indicates specific meaningful information, such as character information and a control code, but null data, which is meaningless data, is inserted or deleted. Therefore, character information is appropriately displayed on a display screen on which the program is displayed. Consequently, the program-length adjustment system 1 does not need work for recording CC data again in processed material data for which the program length has been extended or reduced, and largely reduces the load imposed on the program producer. In addition, since the work for recording CC data again in processed material data is not necessary, the program-length adjustment system 1 can generate processed material data within a short period. Therefore, when processed material data having a plurality of program lengths is generated, the program-length adjustment system 1 largely increases a cost reduction effect due to a reduction in time required for generating the data.

The program-length adjustment system 1 provides users with a high convenience.

The present invention is not limited to the above-described embodiment. For example, in the above-described embodiment, the program-length adjustment system 1 applies processing to the original material data on which CC data has been superimposed, for simplicity of description. Data other than CC data may be superposed. The processing can be applied to the original material data on which text data or XDS has been superposed, in the same way as when CC data is superposed. In other words, the present invention can be applied to any program-accompanying data superposed on the original material data, such as line-21 data.

In the above-described embodiment, the original material data recorded in the video tape VT_{P} is reproduced by the use of the reproduction VTR 10, and processed material data for which the program length has been extended or reduced by the program-play apparatus 100 is recorded into the video tape VT_{R} with the use of the recording VTR 20. In the present invention, media in which material data is recorded may be other than video tapes. Disk-shaped recording media, such as an optical disk, a magneto-optical disk, or a hard disk, or recording media of other forms can be used.

Furthermore, in the above-described embodiment, the program-play apparatus 100 is connected to the reproduction VTR 10 and to the recording VTR 20, and the program-play apparatus 100 inserts or deletes CC data. The present invention can be applied to a case in which the reproduction VTR 10 or the recording VTR 20 is provided with the function of the program-play apparatus 100. The present invention can also be applied to a case in which the reproduction VTR 10, the program-play apparatus 100, and the recording VTR 20 are integrated into one apparatus.

In this way, the present invention can be applied to many appropriately modified cases within the scope and spirit of the invention.

What is claimed is:

1. A data processing apparatus for processing program-accompanying data which accompanies a program, comprising:
data taking-in means for taking in the program-accompanying data superposed on video data in the original material data constituting the program; and
data output means for inserting or deleting meaningless data into or from the program-accompanying data taken in by the data taking-in means, in response to the insertion or deletion of an image constituting the video data, and for outputting as new program-accompanying data.

2. A data processing apparatus according to claim 1, wherein the data output means inserts or deletes the meaningless data into or from both the first and second fields of the program-accompanying data taken in by the data taking-in means.

3. A data processing apparatus according to claim 1, wherein the data output means inserts or deletes the meaningless data so as not to mix program-accompanying data corresponding to different fields.

4. A data processing apparatus according to claim 1, wherein the data output means inserts or deletes the meaningless data so as not to make the sequence relationship between the first and second fields in the new program-accompanying data and the sequence relationship between the first and second fields in the program-accompanying data of the original material data different.

5. A data processing apparatus according to claim 1, wherein the data taking-in means takes in current-time information in association with the program-accompanying data.

6. A data processing apparatus according to claim 5, wherein the data taking-in means stores the taken-in program-accompanying data and current-time information in storage means.

7. A data processing apparatus according to claim 1,
wherein processing-method request information indicating whether an image constituting the video data is inserted or deleted in units of frames or fields is given to the data output means, and
the data output means stores the processing-method request information in storage means.

8. A data processing apparatus according to claim 7,
wherein reading-start-time information indicating the time when the program-accompanying data taken in by the data taking-in means is read is given to the data output means, and
the data output means stores the reading-start-time information in the storage means.

9. A data processing apparatus according to claim 8,
wherein regular frame pulses are given to the data output means, and
the data output outputs program-accompanying data associated with the time corresponding to the reading-start-time information, in response to the frame pulses.

10. A data processing apparatus according to claim 9,
wherein an insertion or deletion pulse indicating that the meaningless data is to be inserted or deleted into or from the program-accompanying data taken in by the data taking-in means is given to the data output means, and
the data output starts processing for inserting or deleting the meaningless data into or from the new program-accompanying data in response to the insertion or deletion pulse.

11. A data processing method for processing program-accompanying data which accompanies a program, comprising:
a data taking-in step of taking in the program-accompanying data superposed on video data in the original material data constituting the program; and
a data output step of inserting or deleting meaningless data into or from the program-accompanying data taken in in the data taking-in step, in response to the insertion or deletion of an image constituting the video data, and of outputting as new program-accompanying data.

12. A data processing method according to claim 11, wherein, in the data output step, the meaningless data is inserted or deleted into or from both the first and second fields of the program-accompanying data taken in in the data taking-in step.

13. A data processing method according to claim 11, wherein, in the data output step, the meaningless data is inserted or deleted so as not to mix program-accompanying data corresponding to different fields.

14. A data processing method according to claim 11, wherein, in the data output step, the meaningless data is inserted or deleted so as not to make the sequence relationship between the first and second fields in the new program-accompanying data and the sequence relationship between the first and second fields in the program-accompanying data of the original material data different.

15. A data processing method according to claim 11, wherein, in the data taking-in step, current-time information is taken in in association with the program-accompanying data.

16. A data processing method according to claim 15, wherein, in the data taking-in step, the taken-in program-accompanying data and current-time information are stored in storage means.

17. A data processing method according to claim 11, wherein, in the data output step, processing-method request information indicating whether an image constituting the video data is inserted or deleted in units of frames or fields is given, and the processing-method request information is stored in storage means.

18. A data processing method according to claim 17, wherein, in the data output step, reading-start-time information indicating the time when the program-accompanying data taken in in the data taking-in step is read is given, and the reading-start-time information is stored in the storage means.

19. A data processing method according to claim 18, wherein, in the data output step, regular frame pulses are given, and program-accompanying data associated with the time corresponding to the reading-start-time information is output in response to the frame pulses.

20. A data processing method according to claim 19, wherein, in the data output step, an insertion or deletion pulse indicating that the meaningless data is to be inserted or deleted into or from program-accompanying data taken in in the data taking-in step is given, and processing for inserting or deleting the meaningless data into or from the new program-accompanying data is started in response to the insertion or deletion pulse.

21. A program-length extension and reduction apparatus for extending and reducing the program length of the original material data constituting a program to generate processed material data, comprising:
video-data storage means for storing video data of the original material data reproduced from a predetermined recording medium and sent by a reproduction apparatus;
program-length extension and reduction processing means for inserting or deleting an image constituting the video data by overlap reading or skip reading from the video-data storage means according to a program-length extension and reduction rate based on the program length of the original material data and the program length of the processed material data to extend or reduce the program length of the original material data;
data taking-in means for taking in program-accompanying data which accompanies the program, superposed on the video data; and
data output means for inserting or deleting meaningless data into or from the program-accompanying data taken in by the data taking-in means, in response to the insertion or deletion of an image constituting the video data, performed by the program-length extension and reduction means, and for outputting as new program-accompanying data.

22. A program-length extension and reduction apparatus according to claim 21, wherein the data output means inserts or deletes the meaningless data into or from both the first and second fields of the program-accompanying data taken in by the data taking-in means.

23. A program-length extension and reduction apparatus according to claim 21, wherein the data output means inserts or deletes the meaningless data so as not to mix program-accompanying data corresponding to different fields.

24. A program-length extension and reduction apparatus according to claim 21, wherein the data output means inserts or deletes the meaningless data so as not to make the sequence relationship between the first and second fields in the new program-accompanying data and the sequence relationship between the first and second fields in the program-accompanying data of the original material data different.

25. A program-length extension and reduction apparatus according to claim 21, further comprising current-time-information generation means for generating current-time information,
wherein the data taking-in means takes in the current-time information in association with the program-accompanying data.

26. A program-length extension and reduction apparatus according to claim 25, further comprising storage means for storing the program-accompanying data and the current-time information taken in by the data taking-in means.

27. A program-length extension and reduction apparatus according to claim 21,
further comprising processing-method-request-information generation means for generating processing-method request information indicating whether an image constituting the video data is inserted or deleted in units of frames or fields, and
storage means for storing the processing-method request information,
wherein the data output means stores the processing-method request information given from the processing-method-request-information generation means, in the storage means.

28. A program-length extension and reduction apparatus according to claim 27,
further comprising reading-start-time-information generation means for generating reading-start-time information indicating the time when the program-accompanying data taken in by the data taking-in means is read,
wherein the data output means stores the reading-start-time information given from the reading-start-time-information generation means, in the storage means.

29. A program-length extension and reduction apparatus according to claim 28,
further comprising frame-pulse generation means for generating regular frame pulses,
wherein the data output means outputs program-accompanying data associated with the time corresponding to the reading-start-time information, in response to the frame pulses given from the frame-pulse generation means.

30. A program-length extension and reduction apparatus according to claim 29,
further comprising insertion-pulse or deletion-pulse generation means for generating an insertion pulse or a deletion pulse indicating that the meaningless data is to be inserted or deleted into or from program-accompanying data taken in by the data taking-in means,
wherein the data output means starts processing for inserting or deleting the meaningless data into or from the new program-accompanying data in response to the insertion pulse or the deletion pulse given from the insertion-pulse or deletion-pulse generation means.

31. A program-length extension and reduction apparatus according to claim 21, wherein the program-length extension and reduction processing means divides the original material data into editing blocks each formed of a plurality of images, and extends or reduces the program length of the original material data in units of editing blocks.

32. A program-length extension and reduction apparatus according to claim 31, wherein the program-length extension and reduction processing means specifies the number of images constituting the editing block so that the amount of extension or reduction per editing block is equal to or smaller than the storage capacity of the video-data storage means.

33. A program-length extension and reduction apparatus according to claim 21, further comprising data separation means for separating at least the video data from the original material data.

34. A program-length extension and reduction apparatus according to claim 21, further comprising program-accompanying-data separation means for separating the program-accompanying data from the original material data.

35. A program-length extension and reduction apparatus according to claim 21, further comprising data synthesis means for synthesizing at least the new program-accompanying data with video data for which the program length has been extended or reduced.

36. A program-length extension and reduction method for extending and reducing the program length of the original material data constituting a program to generate processed material data, comprising:
a video-data storage step of storing video data of the original material data reproduced from a predetermined recording medium and sent by a reproduction apparatus, into video-data storage means;
a program-length extension and reduction processing step of inserting or deleting an image constituting the video data by overlap reading or skip reading from the video-data storage means according to a program-length extension and reduction rate based on the program length of the original material data and the program length of the processed material data to extend or reduce the program length of the original material data;
a data taking-in step of taking in program-accompanying data which accompanies the program, superposed on the video data; and
a data output step of inserting or deleting meaningless data into or from the program-accompanying data taken in in the data taking-in step, in response to the insertion or deletion of an image constituting the video data, performed in the program-length extension and reduction step, and of outputting as new program-accompanying data.

37. A program-length extension and reduction method according to claim 36, wherein, in the data output step, the meaningless data id inserted or deleted into or from both the first and second fields of the program-accompanying data taken in in the data taking-in step.

38. A program-length extension and reduction method according to claim 36, wherein, in the data output step, the meaningless data is inserted or deleted so as not to mix program-accompanying data corresponding to different fields.

39. A program-length extension and reduction method according to claim 36, wherein, in the data output step, the meaningless data is inserted or deleted so as not to make the sequence relationship between the first and second fields in the new program-accompanying data and the sequence relationship between the first and second fields in the program-accompanying data of the original material data different.

40. A program-length extension and reduction method according to claim 36, further comprising a current-time-information generation step of generating current-time information,
wherein, in the data taking-in step, the current-time information is taken in in association with the program-accompanying data.

41. A program-length extension and reduction method according to claim 40, wherein, in the data taking-in step, the taken-in program-accompanying data and current-time information are stored in storage means.

42. A program-length extension and reduction method according to claim 36,
further comprising a processing-method-request-information generation step of generating processing-method request information indicating whether an image constituting the video data is inserted or deleted in units of frames or fields,
wherein, in the data output step, the processing-method request information generated in the processing-method-request-information generation step is given and stored in the storage means.

43. A program-length extension and reduction method according to claim 42,
further comprising a reading-start-time-information generation step of generating reading-start-time information indicating the time when the program-accompanying data taken in in the data taking-in step is read,
wherein, in the data output step, the reading-start-time information generated in the reading-start-time-information generation step is given and stored in the storage means.

44. A program-length extension and reduction method according to claim 43,
further comprising a frame-pulse generation step of generating regular frame pulses,
wherein, in the data output step, the frame pulses generated in the frame-pulse generation step are given, and program-accompanying data associated with the time corresponding to the reading-start-time information is output in response to the frame pulses.

45. A program-length extension and reduction method according to claim 44,
further comprising an insertion-pulse or deletion-pulse generation step of generating an insertion pulse or a deletion pulse indicating that the meaningless data is to be inserted or deleted into or from program-accompanying data taken in in the data taking-in step,
wherein, in the data output step, the insertion pulse or the deletion pulse generated in the insertion-pulse or deletion-pulse generation step is given, and processing for inserting or deleting the meaningless data into or from the new program-accompanying data is started in response to the insertion pulse or the deletion pulse.

46. A program-length extension and reduction method according to claim 36, wherein, in the program-length extension and reduction processing step, the original material data is divided into editing blocks each formed of a plurality of images, and the program length of the original material data is extended or reduced in units of editing blocks.

47. A program-length extension and reduction method according to claim 46, wherein, in the program-length extension and reduction processing step, the number of images constituting the editing block is specified so that the amount of extension or reduction per editing block is equal to or smaller than the storage capacity of the video-data storage means.

48. A program-length extension and reduction method according to claim 36, further comprising a data separation step of separating at least the video data from the original material data.

49. A program-length extension and reduction method according to claim 36, further comprising a program-accompanying-data separation step of separating the program-accompanying data from the original material data.

50. A program-length extension and reduction method according to claim 36, further comprising a data synthesis step of synthesizing at least the new program-accompanying data with video data for which the program length has been extended or reduced.
